(19) United States
(12) Patent Application Publication
(10) Pub. No.: US 2009/0197192 A1
(43) Pub. Date: Aug. 6, 2009

(54) MAGNETIC TONER

(75) Inventors: Shuichi Hiroko, Susono-shi (JP); Tadashi Dojo, Numazu-shi (JP); Michihisa Magome, Mishima-shi (JP); Eriko Yanase, Suntou-gun (JP); Takashi Matsui, Suntou-gun (JP); Tomohisa Sano, Suntou-gun (JP); Akira Sakakibara, Susono-shi (JP); Yoshitaka Suzumura, Mishima-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/420,986

(22) Filed: Apr. 9, 2009

Related U.S. Application Data
(63) Continuation of application No. PCT/JP2008/070147, filed on Oct. 29, 2008.

(30) Foreign Application Priority Data
Oct. 31, 2007 (JP) 2007-283188

(51) Int. Cl. G03G 9/083

(52) U.S. Cl. 430/106.2; 430/105

(57) ABSTRACT

A magnetic toner having magnetic toner particles containing at least a binder resin and a magnetic material, wherein, in the test of dissolution level of the magnetic material, the dissolution percentages S₃ (% by mass), S₁₅ (% by mass) and S₃₀ (% by mass), and the dissolution level proportion S_{c} satisfy the following expressions: 0.5≦S₃≦10, 40≦S₁₅≦80, 1.2≦S_{c}[=(S₁₅−S₃)/(S₃₀−S₁₅)]≦10; and the magnetic toner has a dielectric loss factor (tan δ) at 25° C. and at a frequency 1.0×10⁴ Hz, within the range of from 2.0×10⁻³ or more to 1.5×10⁻² or less.

This application is a continuation of International Application No. PCT/JP2008/070147, filed Oct. 29, 2008, which claims the benefit of Japanese Patent Application No. 2007-283188, filed Oct. 31, 2007.

### BACKGROUND OF THE INVENTION

This invention relates to a toner used in recording processes utilizing electrophotography, electrostatic recording, electrostatic printing or toner jet recording.

### RELATED BACKGROUND ART

A number of methods are conventionally known as methods for electrophotography. In general, copies or prints are obtained by forming an electrostatic latent image on an electrostatically charged image bearing member (hereinafter also “photosensitive member”) by utilizing a photoconductive material and by various means, subsequently developing the latent image by the use of a toner to form a toner image as a visible image, further transferring the toner image to a recording medium such as paper as occasion calls, and then fixing the toner image onto the recording medium by the action of heat and/or pressure. Apparatus for such image formation include copying machines, printers and so forth.

These printers or copying machines are being changed over from analogue machines to digital machines, and are being made compact and energy-saving. Also, as the printers are being made compact in recent years, there have come to be less restriction on places where they are placed, and their service environments have become various. Accordingly, it is required for them to less cause image defects with time even in various environments, and to maintain a high image quality.

In methods of developing toner images, a magnetic one-component development system making use of a magnetic toner is preferably used, as it requires no carrier and is advantageous for making the apparatus compact. In a magnetic toner used in the magnetic one-component development system, a finely powdery magnetic material, a wax and so forth are dispersed in its particles in a fairly large quantity, and hence how the magnetic material and wax and a binder resin are present therein has a great influence on fixing performance, fluidity, environmental stability, triboelectric chargeability and so forth of the toner.

In such a one-component development system, the toner is made to pass a gap between a developing sleeve and a toner control member so as to be electrostatically charged. In that course, a great stress is applied to the toner, and hence there come about problems of what is called toner deterioration, such that any treating agent added later externally to toner base particles may become buried in or liberated from toner particles, that the toner base particles may come to chip and that the magnetic material fine powder present on the particle surfaces may come off.

With progress of such toner deterioration, when used repeatedly the toner tends to become low in charge quantity, or cause image defects accompanied by the faulty charging that may come where any fine powder thereby produced or the magnetic material fine powder sticks to the developing sleeve and toner control member.

To prevent such a phenomenon, it is attempted, as disclosed in Japanese Patent Application Laid-open No. H11-295925, to improve durability (running performance) of a magnetic toner by making toner particles spherical so as to be improved in their surface smoothness. In this method, however, there still remain problems on how charge characteristics be made stable against environmental variation and the like.

With regard to such deterioration of image characteristics that is accompanied by the presence of the magnetic material present on the toner particle surfaces, some proposals have been made also in an aspect of toner structure.

For example, in Japanese Patent Application Laid-open Nos. S60-003647 and S63-089867, reports are made on a special toner in which magnetic material particles are contained only at specific portions in the interiors of toner particles. Stated specifically, it is a toner for pressure fixing which is produced through several-stage steps that a magnetic material is made to adhere to toner base particles by a dry process after their production and thereafter shell layers are formed thereon, thus it is a toner in which the magnetic material is present only in toner particle intermediate layers. In Japanese Patent Application Laid-open No. H07-209904, a report is also made on a toner which is so structured that resin layers having no magnetic material particles present therein are formed in the vicinity of toner particle surfaces and in a stated thickness or more.

It, however, has become aware that the toners having such forms have some problems on how they can achieve high image quality when they have an average particle diameter of as small as 9 μm or less. Such toners to toner particle surfaces of which the magnetic material may little come bare can promise a high charge quantity, but may cause charge-up when images are reproduced on a large number of sheets by using a high-speed machine, in particular, when images are reproduced on a large number of sheets in a low-humidity environment, resulting in a decrease in image density in some cases. Further, in such toners, although toners promising a high charge quantity are obtainable, toner layers on images may come so denser as to become low in dot reproducibility. That is, a lowering of image quality may result, such that spots of tone appear around line images, trailed images appear, images smear from their trailing edges, or line images are too thick formed.

Still further, the layers of a magnetic material that are present in toner particles may inhibit a release agent or the like from exuding out of the toner particles to tend to bring about problems such that the toner comes to have a low fixing performance and it becomes low releasable to cause contamination of fixing members.

As also disclosed in Japanese Patent Application Laid-open Nos. 2005-157318 and 2005-265958, it is attempted to control charge characteristics by controlling the dispersibility of a magnetic material to control toner physical properties such as dielectric loss factor and dielectric constant within specific ranges, so as to keep image density from decreasing, save toner consumption and prevent image deterioration. There, however, is a tendency for the magnetic material in toner particles to be so made present as to stand dispersed in the whole individual toner particles, and this is a trend that is disadvantageous to the keeping of the magnetic material from coming bare to the toner particle surfaces. Thus, there still is room for improvement in order to prevent faulty images especially in severe environments.

As also disclosed in Japanese Patent Application Laid-open No. 2003-195560, the surface properties and particle shape of a magnetic material used in a toner are controlled so as to improve developing performance and running performance in a high-speed system. There, however, is a tendency for the magnetic material in toner particles to be so made present as to stand dispersed in the whole individual toner particles, and this is a trend that is disadvantageous to the keeping of the magnetic material from coming bare to the toner particle surfaces. Thus, there still is room for improvement in order to prevent faulty images especially in severe environments.

Further, in Japanese Patent Application Laid-open No. 2005-107520, a toner is proposed which contains a stated amount or more of toner particles in which a magnetic material is unevenly so distributed as to be much present in the vicinity of particle surfaces while the magnetic material is kept from coming bare to the surfaces of the toner particles. However, as a result of studies made on the state of dispersion of individual magnetic material particles, it has been found to be what can not be said satisfactory in regard to the state of dispersion of the magnetic material in the regions where the magnetic material is present in a high concentration that are formed by the magnetic material thus unevenly distributed.

### SUMMARY OF THE INVENTION

An object of the present invention is to provide a toner having resolved such problems as discussed above.

Stated specifically, it is to provide a magnetic toner which can not easily be affected by any environmental variations, can achieve stable image density and can keep any image defects from occurring.

A further object of the present invention is to provide a magnetic toner which can keep any image defects form occurring even in an environment very disadvantageous to the controlling of chargeability, as in a low-temperature environment.

The present invention is concerned with a magnetic toner which is a magnetic toner having magnetic toner particles containing at least a binder resin and a magnetic material, wherein; in a test in which the magnetic toner is dispersed in 5 mol/liter hydrochloric acid to dissolve the magnetic material, and where the dissolution percentage of the magnetic material with respect to the total content of the magnetic material at a point of time of 3 minutes after the magnetic toner has begun to be dispersed in the hydrochloric acid is represented by S₃ (% by mass) and the dissolution percentage of the magnetic material with respect to the total content of the magnetic material at a point of time of 15 minutes after the magnetic toner has begun to be dispersed in the hydrochloric acid is represented by S₁₅ (% by mass), the S₃ and the S₁₅ satisfy the following expressions: 0.5≦S₃≦10, 40≦S₁₅≦80; where the dissolution percentage of the magnetic material with respect to the total content of the magnetic material at a point of time of 30 minutes after the magnetic toner has begun to be dispersed in the hydrochloric acid is represented by S₃₀ (% by mass), the proportion S_{c} of the dissolution level of the magnetic material at from 3 minutes to 15 minutes after the magnetic toner has begun to be dispersed in the hydrochloric acid to the dissolution level of the magnetic material at from 15 minutes to 30 minutes after the magnetic toner has begun to be dispersed in the hydrochloric acid, represented by (S₁₅−S₃)/(S₃₀−S₁₅), satisfies the following expressions:

1.2≦S_{c}[=(S₁₅−S₃)/(S₃₀−S₁₅)]≦10; and

the magnetic toner has a dielectric loss factor (tan δ) at 25° C. and at a frequency 1.0×10⁴ Hz, within the range of from 2.0×10⁻³ or more to 1.5×10⁻² or less.

According to the present invention, a magnetic toner can be obtained which has a superior low-temperature fixing performance without regard to service environments, can achieve stable image density and can keep any image defects from occurring. In particular, it can keep any image defects from occurring especially in severe environments as in a low-temperature environment.

### BRIEF DESCRIPTION OF THE DRAWINGS

FIG. 1 shows an example of an image forming apparatus used in Examples of the present invention.

FIG. 2 is an enlarged view of a developing part.

### DETAILED DESCRIPTION OF THE INVENTION

The dissolution of toner by hydrochloric acid as referred to in the present invention is described in detail.

Where the magnetic toner is dispersed in 5 mol/liter hydrochloric acid, components contained in the toner and dissolved by the hydrochloric acid are extracted from toner particles to come present in the hydrochloric acid. In a magnetic toner like that which contains magnetic iron oxide as a magnetic material, the chief component that is extracted is the magnetic iron oxide. Where any other charge control agent and colorant used therein are soluble in the hydrochloric acid, these are also extracted. However, the magnetic iron oxide is usually in a very larger content than the other components, and hence it comes that the extract is almost what comes from the magnetic iron oxide.

In what is tested in the present invention, the time for which the component is extracted by the hydrochloric acid is changed, whereby the state of presence of the magnetic material in toner particles from their surfaces to interiors can be estimated. More specifically, what is extracted until a point of time of 3 minutes after the magnetic toner has begun to be dispersed in 5 mol/liter hydrochloric acid is the magnetic material that is present in the toner particles at their outermost surface portions. Then, the magnetic material moiety extracted until a point of time of 15 minutes is the magnetic material that is present in the toner particles from the vicinity of their surfaces toward their centers, and the magnetic material moiety extracted until a point of time of 30 minutes is the magnetic material that is present in the toner particles further toward their centers.

In the present invention, the dissolution percentage (S₃) of the magnetic material with respect to the total content of the magnetic material at a point of time of 3 minutes after the magnetic toner has begun to be dispersed in 5 mol/liter hydrochloric acid is from 0.5% by mass or more to 10% by mass or less, and it may preferably be 5% by mass or less. Thus, the magnetic material that is present at the outermost surface portions is in a small level. This makes the toner little affected by any moisture absorption due to the magnetic material, and hence charge characteristics excellent in environmental stability can be achieved as for the toner. Further, even where it has received stress acting between the developing sleeve and the toner control member in the magnetic one-component development system, the magnetic material can be made less come liberated from toner particles and the toner carrying member can be kept from being contaminated by the magnetic material liberated. If the S₃ is less than 0.5% by mass, the magnetic material that is a low-resistance component acting as a leak site is little present at the outermost surface portions of the toner particles, and hence the charge-up tends to occur in a low-humidity environment to make any stable charge characteristics not achievable. If on the other hand the S₃ is more than 10% by mass, the toner tends to have a low charge quantity in a high-humidity environment, resulting in a low environmental stability. The magnetic material having such S₃ makes it difficult to keep itself from being liberated in a large quantity, to tend to cause a lowering of image quality such as dot reproducibility.

In the present invention, the dissolution percentage (S₁₅) of the magnetic material with respect to the total content of the magnetic material at a point of time of 15 minutes after the magnetic toner has begun to be dispersed in 5 mol/liter hydrochloric acid is from 40% by mass or more to 80% by mass or less, and may preferably be from 45% by mass or more to 75% by mass or less. The S₁₅ corresponds to the level of the magnetic material that is present in the vicinity of the toner particle surfaces. In the present invention, the magnetic material is unevenly so distributed as to be much present in the vicinity of particle surfaces to such an extent that the S₁₅ is within the above range, and this enables the toner to be dramatically improved in stress resistance.

The proportion S_{c} [=(S₁₅−S₃)/(S₃₀−S₁₅)] of the dissolution level of the magnetic material at from 3 minutes to 15 minutes after the magnetic toner has begun to be dispersed in the hydrochloric acid to the dissolution level of the magnetic material at from 15 minutes to 30 minutes after the magnetic toner has begun to be dispersed in the hydrochloric acid is from 1.2 or more to 10 or less, and may preferably be from 1.5 or more to 8 or less. The proportion S_{c} of the dissolution levels represents the ratio of the level of the magnetic material present in the vicinity of particle surfaces to the level of the magnetic material present on the more inner side from the vicinity of particle surfaces. A case in which the S_{c} is small, in particular, a case in which it is close to 1 is meant to be that the magnetic material stands uniformly distributed in the toner particles from the vicinity of their surfaces toward their interiors. On the other hand, a case in which the S_{c} is large corresponds to a state where the magnetic material has been made locally present on the more particle surface side. In the present invention, it is important to control the S_{c} that represents the very state of presence of the magnetic material in the vicinity of particle surfaces. Making this value proper enables simultaneous achievement of the stress resistance of toner, the stabilization of high image quality and also the fixing performance.

If the S₁₅ is less than 40% by mass and the S_{c} is less than 1.2, the magnetic material that is present in the vicinity of particle surfaces is in a small level or it may come present in the vicinity of particle surfaces in a uniform state. This may make the toner have a low stress resistance to tend to cause the toner deterioration as a result of long-term service. If on the other hand the S₁₅ is more than 80% by mass and the S_{c} is more than 10, the magnetic material comes concentrated in the vicinity of particle surfaces, and hence this may inhibit the release agent or the like from exuding to the toner particle surfaces, so that the toner may come to have a low fixing performance and it becomes low releasable to tend to cause contamination of fixing members.

The dissolution percentage (S₃₀) of the magnetic material with respect to the total content of the magnetic material at a point of time of 30 minutes after the magnetic toner has begun to be dispersed in 5 mol/liter hydrochloric acid may preferably be 80% by mass or more. In such a case, the magnetic material is appropriately unevenly so distributed as to be much present toward the particle surface side and the toner can have better stress resistance in a high-temperature environment.

If the present invention, the magnetic material is unevenly so distributed as to be much present at a certain distance from toner particle surfaces as shown in the above dissolution by hydrochloric acid. This controls charge uniformity of the toner at a high level, and further enables the magnetic material to be kept from coming bare to the toner particle surfaces and a wax or the like to be enclosed on the inside of shells the magnetic material forms, bringing an improvement in environmental stability of the toner.

In the present invention, in addition to the controlling of the proportion of dissolution when the magnetic material is dissolved with hydrochloric acid, the magnetic toner also has a dielectric loss factor (tan δ) which has been controlled within the range of from 2.0×10⁻³ or more to 1.5×10⁻² or less as measured at 25° C. and at a frequency 1.0×10⁴ Hz. Controlling the dielectric loss factor within the above range enables the toner to enjoy charge stability and uniformity which are free of dependence on environment. The dielectric loss factor may more preferably be in a value of from 3.0×10⁻³ or more to 1.0×10⁻² or less.

A conductive substance like the magnetic material and a non-conductive substance like the binder resin differ in follow-up performance to an alternating electric field applied. Hence, in the case when the magnetic material stands unevenly so distributed as to be much present in specific regions in the toner particles as in the present invention, the toner may undergo dielectric polarization with difficulty, compared with a case in which the magnetic material stands uniformly dispersed over the whole, thus it has a larger value of dielectric loss factor, as so considered.

However, the magnetic toner of the present invention is one having a relatively small dielectric loss factor even though the magnetic material stands thus unevenly distributed. As the reason therefor, the present inventors consider it to be that individual particles of the magnetic material have finely been dispersed in the state of primary particles as far as possible and, in addition thereto, the magnetic material stands thus unevenly distributed and further has a special state of dispersion that the magnetic material is dispersed in a less non-uniform state also between the toner particles themselves.

Thus, the magnetic material stands unevenly so distributed as to have a shell structure and also, taking note of individual magnetic material particles, the respective magnetic material particles stand dispersed in the form of primary particles, and moreover they are dispersed without difference in state of distribution of the magnetic material between individual toner particles. This enables the toner to be made uniform and stable in its magnetic binding force and chargeability. This also enables the toner to be kept from causing image defects such as fog even under conditions disadvantageous to the controlling of chargeability as in a low-temperature and low-humidity environment, and further to maintain a good dot reproducibility even in a high-temperature and high-humidity environment.

Where the toner has a dielectric loss factor of less than 2.0×10⁻³, the magnetic material is considered to stand uniformly dispersed over the whole toner particles, thus the stress resistance may lower that is achievable by making the magnetic material thus unevenly distributed. Hence, this makes the toner inferior in the charge stability and uniformity which are free of dependence on environmental variations, tending to cause difficulties in images, such as fog, and also resulting in a low dot reproducibility.

In addition, since the magnetic material does not stand unevenly distributed in the toner particles, the toner tends to be affected by environmental variations to come inferior in stability with time, such as storage stability.

Where the toner has a dielectric loss factor of more than 1.5×10⁻², it is considered that the magnetic material stands excessively unevenly dispersed in the toner particles or that the magnetic material does not stand dispersed therein in the form of primary particles or it is dispersed in a less non-uniform state between the toner particles themselves. In such a case, the toner tends to be electrostatically charged in excess to tend to cause difficulties such as fog. Further, the wax may be inhibited from exuding out of toner particles at the time of fixing, and hence the toner may have an inferior low-temperature fixing performance. In addition, the toner may come greatly non-uniform in its magnetic binding force between toner particles and in chargeability to have an inferior uniformity in chargeability. As the result, the toner tends to cause difficulties in images in severe environments.

As described above, in the present invention, it is important for the magnetic material to be incorporated in a finely dispersed state. For this end, it is important for the magnetic material to have been kept improved in dispersibility as far as possible.

In the present invention, the magnetic toner can also be a toner having been made to have much stable charge characteristics by controlling the shape of toner particles. Some effects are obtainable by making the toner particles close to those having a truly spherical shape, i.e., higher in circularity. A first effect is that the toner can have a uniform charge quantity distribution with ease and this enables reduction of what is called a phenomenon of selection in which only toner particles having a specific charge quantity are consumed with environmental variations and repeated used, and enables the toner to be kept from changing in charge quantity. A second effect is that, even where the toner has received the stress acting between the developing sleeve and the toner control member in the magnetic one-component development system, any fine powder that may come when the toner is pulverized there and the magnetic material that may be liberated from toner particles can be made less come about and this enables the toner carrying member to be kept from being contaminated by such fine powder. Making such shape control makes proper the state of presence of the above magnetic material and, concurrently therewith, makes it possible to obtain a toner having much stable charge characteristics.

In the present invention, the magnetic toner may preferably have an average circularity of 0.960 or more. Inasmuch as it has an average circularity of 0.960 or more, the effects stated above can sufficiently be obtained.

The magnetic toner of the present invention may also preferably have a weight average particle diameter of from 4 μm to 10 μm, and more preferably from 6 μm to 9 μm. In the toner having such particle diameter, the state of presence of magnetic material layers formed by the magnetic material unevenly distributed in the toner particles as described above can especially be stable, thus the part where the magnetic material is densely present and the part where it is sparsely present can especially be well-balanced.

As the magnetic material used in the magnetic toner of the present invention, any conventionally known magnetic material may be used. The magnetic material to be incorporated in the magnetic toner particles may include iron oxides such as magnetite, maghemite and ferrite, and iron oxides including other metal oxides; metals such as Fe, Co and Ni, or alloys of any of these metals with any of metals such as Al, Co, Cu, Pb, Mg, Ni, Sn, Zn, Sb, Be, Bi, Cd, Ca, Mn, Se, Ti, W and V, and mixtures of any of these.

Stated specifically, it may include triiron tetraoxide (Fe₃O₄), iron sesquioxide (γ-Fe₂O₃), zinc iron oxide (ZnFe₂O₄), yttrium iron oxide (Y₃Fe₅O₁₂), cadmium iron oxide (CdFe₂O₄), gadolinium iron oxide (Gd₃Fe₅O₁₂), copper iron oxide (CuFe₂O₄), lead iron oxide (PbFe₁₂O₁₉), nickel iron oxide (NiFe₂O₄), neodymium iron oxide (NdFe₂O₃), barium iron oxide (BaFe₁₂O₁₉), magnesium iron oxide (MgFe₂O₄), manganese iron oxide (MnFe₂O₄), lanthanum iron oxide (LaFeO₃), iron powder (Fe), cobalt powder (Co) and nickel powder (Ni). In the present invention, at least magnetic iron oxide may be contained as the magnetic material, and one or two or more of other materials may optionally be selected and used.

Such a magnetic iron oxide may preferably have a BET specific surface area, as measured by nitrogen gas absorption, of from 2 m²/g or more to 30 m²/g or less, and particularly from 3 m²/g or more to 28 m²/g or less, and also may preferably have a Mohs hardness of from 5 or more to 7 or less.

As the particle shape of the magnetic iron oxide, it may be, e.g., octahedral, hexahedral, spherical, acicular or flaky. Octahedral, hexahedral, spherical or amorphous ones are preferred as having less anisotropy, which are preferable in order to improve image density. Such particle shapes of the magnetic material may be ascertained by SEM or the like.

The magnetic iron oxide may preferably have, as its particle size, a number average particle diameter of from 0.10 μm or more to 0.30 μm or less and have particles of 0.10 μm or less in diameter in a content of 40% by number or less, and more preferably 30% by number or less, in the measurement of particle size in respect of particles having particle diameters of 0.03 μm or more.

The magnetic iron oxide having number average particle diameter within the above range can keep the tint of images from shifting to a red tint, and can provide sufficient blackness as images. Such a magnetic iron oxide also has so appropriate surface area as to achieve good dispersibility with ease.

Inasmuch as the magnetic iron oxide has particles of 0.10 μm or less in diameter in a content of 40% by number or less in the toner particles, such fine magnetic iron oxide particles have so appropriate surface area as to achieve good dispersibility, and can be kept from agglomerating in the toner particles. As the result, the toner can have better chargeability, and also comes achievable of a higher coloring power. Further, where the magnetic iron oxide has such particles in a content of 30% by number or less, this is preferred because the above tendency can be made higher.

A magnetic iron oxide of less than 0.03 μm in particle diameter may undergo a small stress when the magnetic toner base particles are produced, because of the fact that it has small particle diameter, and hence it may come bare to toner particle surfaces in a low probability. Further, even where it has come bare to toner particle surfaces, it may little act as leak sites to come into substantially no problem. Accordingly, in the present invention, it takes note of the content of particles of 0.03 μm or more in diameter, and defines its percent (%) by number.

In the present invention, it is also preferable for the magnetic iron oxide that, in its fine particles, particles of 0.30 μm or more in diameter are in a content of 40% by number or less, and more preferably 10% by number or less. Inasmuch as the magnetic iron oxide having the particles of 0.30 μm or more in diameter are in a content of 10% by number or less, the toner can have a good coloring power to make it easy to achieve a higher image density. In addition, it can be made easy to make the magnetic iron oxide present up to the vicinities of the surfaces of toner particles and also to disperse the magnetic material uniformly in individual toner particles. More preferably, the particles of 0.30 μm or more in diameter may be in a content of 5% by number or less.

In the present invention, it is preferable to set conditions for producing the magnetic iron oxide so as to fulfill the above conditions of particle size distribution, or to use one for which the particle size distribution has previously been controlled by, e.g., pulverization and classification. As a method for the classification, preferred are a method making use of, e.g., a precipitation equipment such as a thickener and a means such as a wet-process classifier making use of, e.g., a cyclone.

This magnetic iron oxide may preferably be one having a coercive force of from 1.5 kA/m or more to 12 kA/m or less, a magnetization intensity of from 30 Am²/kg or more to 120 Am²/kg or less (preferably from 40 Am²/kg or more to 80 Am²/kg or less) and a residual magnetization of from 1 Am²/kg or more to 10 Am²/kg or less, as magnetic properties under application of a magnetic field of 79.6 kA/m (1,000 oersteds).

In the present inventions the magnetic iron oxide may have a residual magnetization of 5 Am²/kg or less. This is more preferable because the magnetic iron oxide can be made less magnetically agglomerative and the state of dispersion of the magnetic material can be controlled with ease when the toner is produced.

The toner may also preferably have a magnetization intensity of from 23.0 Am²/kg or more to 33.0 Am²/kg or less under application of a magnetic field of 79.6 kA/m (1,000 oersteds). This is preferable in order to achieve the uniformity of charging. As long as the toner has magnetization intensity within the above range, the force of toner layer thickness control on the image bearing member can be appropriate in the step of development, and uniform charging is readily achievable. In addition, the toner can be kept from magnetically agglomerating, can secure good fluidity on the image bearing member and can be kept from deteriorating.

The toner may also preferably have a residual magnetization of 2.5 Am²/kg or less when magnetized in a magnetic field of 79.6 kA/m (1,000 oersteds).

The magnetic properties of the magnetic material and toner may be measured with a vibration type magnetic-force meter, e.g., VSM P-1-10 (manufactured by Toei Industry Co., Ltd.) under conditions of a temperature of 25° C. and an external magnetic field of 79.6 kA/m.

How to produce the magnetic toner in the present invention is described below.

The magnetic toner of the present invention may be produced even by a pulverization process. The pulverization process, however, requires going through multiple-stage steps in order to satisfy the state of presence of the magnetic material in toner particles in the present invention, and hence it is disadvantageous in view of yield and cost.

In contrast thereto, in a production process in which a polymerizable monomer composition is directly polymerized in an aqueous medium to obtain toner particles (hereinafter termed as a polymerization process), localization/separation tends to take place between polar and non-polar components from the viewpoint of affinity for the aqueous medium. Hence, it is possible to obtain through one step the structure of magnetic material in the present invention, as being preferable.

In producing the toner particles by direct polymerization in an aqueous medium, it is important to use as the magnetic material one having been subjected to uniform and high-degree hydrophobic treatment, where the state of presence of the magnetic material in toner particles can readily be controlled as desired.

Further, in the step of mixing and dispersing the magnetic material and a polymerizable monomer in the course of production, the magnetic material may be subjected to disintegration treatment as a preliminary step to make any agglomerates less form, and further the rate of feeding the magnetic material may be controlled to keep the magnetic material from agglomerating in the polymerizable monomer and promote its dispersion in the form of primary particles.

As a means for the disintegration treatment, it may include a jet mill, an impact type pulverizer, a pin mill, a hammer mill, a sand mill making use of media, Glen mill, Basket mill, a ball mill, Sand grinder and Visco mill.

Stated specifically, it is important to precisely control the quantity of the magnetic material to be fed per unit time, based on the quantity of the polymerizable monomer. If the quantity of the magnetic material to be fed per unit time is extremely low, though the magnetic material is well dispersible, a low productivity may result. If conversely the magnetic material is fed in an extremely large quantity, though advantageous in view of production, it is difficult to keep magnetic material particles from mutually agglomerating, bringing about a disadvantage in dispersibility.

It is preferable to control such feed quantity using as an index the value of C/E where the mass of the polymerizable monomer is represented by E (kg) and the feed rate of the magnetic material by C (kg/s).

In order to achieve the state of dispersion of the magnetic material as specified in the present invention, it is preferable to control the value of C/E within the range of from 2.0×10⁻⁴ or more to 3.0×

10⁻³ or less, more preferably from 2.0×10⁻⁴ or more to 2.0×10⁻³ or less, and still more preferably from 2.0×10⁻⁴ or more to 1.0×10⁻³ or less.

Controlling the feed rate of the magnetic material in this way enables keeping of the state of fine dispersion of the magnetic material distributed unevenly in toner particles as aimed in the present invention.

In the present invention, the magnetic material may preferably be one having been subjected to hydrophobic treatment. The controlling of hydrophobic treatment enables strict control of the state of presence of the magnetic material in the toner particles, and is effective in achieving the unique state of presence of the same as specified in the present invention.

As methods for treating the magnetic iron oxide particle surfaces with a coupling agent or the like, two methods are available which are dry-process treatment and wet-process treatment. In the present invention, the treatment may be carried out by either method. The method of wet-process treatment, carried out in an aqueous medium, is preferred because it may less cause the mutual coalescence of magnetic material particles than the dry-process treatment, carried out in a gaseous phase, and also charge repulsion acts between magnetic material particles themselves as a result of hydrophobic treatment, so that the magnetic material can be surface-treated with the coupling agent substantially in the state of primary particles.

The coupling agent usable in the surface treatment of the magnetic material in the present invention may include, e.g., a silane coupling agent and a titanium coupling agent. What is more preferably usable is the silane coupling agent, which is a compound represented by the following general formula

(A): RₘSiYₙ (A)

wherein R represents an alkoxyl group; m represents an integer of 1 to 3; Y represents an alkyl group, a vinyl group, a methacrylic group, a phenyl group, an amino group, an epoxy group, a mercapto group or a derivative of any of these; n represents an integer of 1 to 3; and m+n is 4.

It may include, e.g., vinyltrimethoxysilane, vinyltriethoxysilane, γ-methacryloxypropyltrimethoxysilane, vinyltriacetoxysilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-hexadecyltrimethoxysilane and n-octadecyltrimethoxysilane.

In particular, the magnetic material particle surfaces may be hydrophobic-treated with an alkyltrialkoxysilane coupling agent represented by the following formula (B):

CₚH₂ₚ₊₁—Si—(OC_{q}H_{2q+1})₃ (B)

wherein p represents an integer of 2 to 20, and q represents an integer of 1 to 3.

In the above formula, if p is smaller than 2, though hydrophobic treatment may be carried out with ease, it may be difficult to provide a sufficient hydrophobic nature. If p is larger than 20, though hydrophobic nature can be sufficient, the magnetic material particles may tend to coalesce one another. Also, if q is larger than 3, the silane coupling agent may have a low reactivity to make it difficult for the magnetic material to be made sufficiently hydrophobic.

Accordingly, it is preferable to use an alkyltrialkoxysilane coupling agent in which, in the above formula, the p represents an integer of 2 to 20 (more preferably an integer of 3 to 15) and the a represents an integer of 1 to 3 (more preferably an integer of 1 or 2). In the treatment, it may be used in an amount of from 0.05 part by mass or more to 20 parts by mass or less, and preferably from 0.1 part by mass or more to 10 parts by mass or less, based on 100 parts by mass of the magnetic material having not been treated.

In the present invention, as a method by which the hydrophobicity of the magnetic material is controlled, it may include a method in which the magnetic material is treated with two or more types of silane coupling agents which differ in the p in the above silane coupling agent. The types of such silane coupling agents and the proportion of the amounts in which the magnetic material is to be treated therewith may appropriately be controlled, whereby a magnetic material can be obtained which has distribution in the degree of hydrophobic treatment.

As a method for the hydrophobic treatment with the coupling agent in an aqueous medium, a method is available in which the magnetic material and coupling agent in suitable quantities are stirred in the aqueous medium.

The aqueous medium is meant to be a medium composed chiefly of water. Stated specifically, the aqueous medium may include water itself, water to which a surface-active agent has been added in a small quantity, water to which a pH adjuster has been added, and water to which an organic solvent has been added. As the surface-active agent, a nonionic surface-active agent such as polyvinyl alcohol is preferred. The surface-active agent may be added in an amount of from 0.1% by mass or more to 5% by mass or less based on the water. The pH adjuster may include inorganic acids such as hydrochloric acid.

The stirring may be carried out by using, e.g., a mixing machine having a stirring blade (stated specifically, a high-shear force mixing machine such as an attritor or TK homomixer), which may sufficiently be so carried out that magnetic material particles may come into primary particles in the aqueous medium.

The magnetic material thus obtained has uniformly been hydrophobic-treated on its particle surfaces, and hence is very well dispersible in the polymerizable monomer composition. Thus, toner particles can be obtained the content of the magnetic material in which stands uniform.

The magnetic iron oxide used as the magnetic material may be produced in the following way, for example.

To an aqueous ferrous salt solution such as an aqueous ferrous sulfate solution, an alkali such as sodium hydroxide is added in an equivalent weight, or more than equivalent weight, with respect to the iron component to prepare an aqueous solution containing ferrous hydroxide into the aqueous solution thus prepared, air is blown while its pH is maintained at pH 7 or above (preferably a pH of 8 to 10), and the ferrous hydroxide is made to undergo oxidation reaction while the aqueous solution is heated at 70° C. or more, to firstly form seed crystals serving as cores of magnetic ion oxide particles.

Next, to a slurry-like liquid containing the seed crystals, an aqueous solution containing ferrous sulfate in about one equivalent weight on the basis of the quantity of the alkali previously added is added. The reaction of the ferrous hydroxide is continued while the pH of the liquid is maintained at 6 or more to 10 or less and air is blown, to cause magnetic iron oxide particles to grow about the seed crystals as cores. With progress of oxidation reaction, the pH of the liquid comes to shift to acid side, but it is preferable for the pH of the liquid not to be made less than 6. At the termination of the oxidation reaction, the pH of the liquid is adjusted, and the liquid is thoroughly stirred so that the magnetic iron oxide particles become primary particles. Then the coupling agent is added, and the mixture obtained is thoroughly mixed and stirred, followed by filtration, drying, and then light disintegration to obtain magnetic iron oxide particles having been hydrophobic-treated. Preferably, the iron oxide particles obtained after the oxidation reaction is completed, followed by washing and filtration, may be again dispersed in a different aqueous medium without drying, and thereafter the pH of the dispersion again formed may be adjusted, where a silane coupling agent may be added with thorough stirring, to carry out hydrophobic treatment.

At any event, it is preferable that the untreated magnetic iron oxide formed in the aqueous solution is made hydrophobic in the state of a water-containing slurry having not gone through the drying step. This is because, if the untreated magnetic iron oxide is dried as it is, its particles may unavoidably mutually agglomerate to come to coalesce and, even if the magnetic iron oxide standing thus agglomerate is subjected to the wet-process hydrophobic treatment, it is difficult to carry out any uniform hydrophobic treatment.

As the ferrous salt used as the aqueous ferrous salt solution when the magnetic iron oxide is produced, it is commonly possible to use iron sulfate formed as a by-product in the manufacture of titanium by the sulfuric acid method, or iron sulfate formed as a by-product as a result of surface washing of steel sheets. Besides ferrous sulfate, it is also possible to use iron chloride or the like.

In the process of producing the magnetic iron oxide by the aqueous-solution method, commonly in order to prevent viscosity from increasing at the time of reaction and in view of the solubility of the iron sulfate, an aqueous ferrous sulfate solution is used in an iron concentration of from 0.5 mol/l or more to 2 mol/l or less. Commonly, the lower the concentration of iron sulfate is, the finer particle size the products tend to have. Also, in the reaction, the more the air is and the lower the reaction temperature is, the finer particles tend to be formed.

In the present invention, it is preferable to use the hydrophobic magnetic iron oxide thus produced.

The magnetic iron oxide used in the magnetic toner of the present invention may preferably be used in an amount of from 10 parts by mass or more to 200 parts by mass or less, more preferably from 20 parts by mass or more to 180 parts by mass or less, and still more preferably from 40 parts by mass or more to 160 parts by mass or less, based on 100 parts by mass of the binder resin. As long as the magnetic iron oxide is mixed in the content within the above range, good coloring power, good developing performance and good fixing performance can be achieved. In addition, the state of dispersion of the magnetic material in toner particles can be controlled with ease.

To determine the average particle diameter and particle size distribution of the magnetic material in the toner particles, they may be measured in the following way.

The toner particles to be observed are well dispersed in epoxy resin, followed by curing for 2 days in an environment of temperature 40° C. to obtain a cured product, which is then cut out in slices by means of a microtome to prepare a sample. The sample is observed under enlargement at 10,000 or more to 40,000 or less magnifications on a transmission electron microscope (TEM), where the projected area of 100 magnetic material particles each in the visual field is measured. The diameter equivalent to a circle equal to the projected area of each particle is found as the particle diameter of the magnetic iron oxide. Further, on the basis of the results obtained, the percent (%) by number of particles of from 0.03 μm or more to 0.10 μm or less in diameter and particles of from 0.30 μm or more in diameter is calculated.

The polymerizable monomer making up the polymerizable monomer composition used in the present invention may include the following.

The polymerizable monomer may include styrene; styrene monomers such as o-methylstyrene, m-methylstyrene, p-methylstyrene, p-methoxystyrene and p-ethylstyrene; acrylic esters such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate and phenyl acrylate; methacrylic esters such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; and other monomers such as acrylonitrile, methacrylonitrile and acrylamides. Any of these polymerizable monomers may be used alone or in the form of a mixture.

Of the foregoing polymerizable monomers, in the present invention, styrene or a styrene derivative may preferably be used alone or in the form of a mixture with other polymerizable monomer. This is preferable in view of developing performance and running performance of the toner.

The magnetic toner of the present invention may preferably contain a release agent in order to improve fixing performance. The release agent may preferably be contained in an amount of from 1 part by mass or more to 30 parts by mass or less, and more preferably from 3 parts by mass or more to 25 parts by mass or less, based on 100 parts by mass of the binder resin. If the release agent is in a content of less than 1 part by mass, the effect to be brought by adding the release agent may be low achievable and also the effect of controlling offset may be low achievable. If on the other hand it is in a content of more than 30 parts by mass, the toner may have a poor long-term storage stability, resulting in a poor fluidity of the magnetic toner and a lowering of image characteristics. Also, release agent components tend to ooze out, resulting in a lowering of running performance especially in a high-temperature and high-humidity environment. Still also, since wax as the release agent is enclosed in a large quantity, the shape of toner particles tends to come distorted.

As the release agent usable in the magnetic toner of the present invention, it may include, e.g., aliphatic hydrocarbon waxes such as low-molecular weight polyethylene, low-molecular weight polypropylene, microcrystalline wax and paraffin wax; oxides of aliphatic hydrocarbon waxes, such as polyethylene oxide wax, or block copolymers of these; waxes composed chiefly of a fatty ester, such as carnauba wax, sasol wax and montanate wax; those obtained by subjecting part or the whole of fatty esters to deoxidizing treatment, such as dioxidized carnauba wax; saturated straight-chain fatty acids such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and melissyl alcohol; polyhydric alcohols such as sorbitol; fatty acid amides such as linolic acid amide, oleic acid amide and lauric acid amide; saturated fatty acid bisamides such as methylenebis(stearic acid amide), ethylenebis(capric acid amide), ethylenebis(lauric acid amide) and hexamethylenebis(stearic acid amide); unsaturated fatty acid amides such as ethylenebis(oleic acid amide), hexamethylenebis(oleic acid amide), N,N′-dioleyladipic acid amide and N,N′-dioleylsebasic acid amide; aromatic bisamides such as m-xylenebisstearic acid amide and N,N′-distearylisophthalic acid amide; fatty acid metal salts (those commonly called metal soap) such as calcium stearate, calcium laurate, zinc stearate and magnesium stearate; grafted waxes obtained by grafting vinyl monomers such as styrene or acrylic acid to fatty acid hydrocarbon waxes; partially esterified products of polyhydric alcohols with fatty acids, such as monoglyceride behenate; methyl esterified products having a hydroxyl group, obtained by, e.g., hydrogenation of vegetable fats and oils; and long-chain alkyl alcohols or long-chain alkyl carboxylic acids, which have 12 or more carbon atoms.

Release agents particularly preferably usable in the present invention may include aliphatic hydrocarbon waxes. Such aliphatic hydrocarbon waxes may include, e.g., low-molecular weight alkylene polymers obtained by polymerizing alkylenes by radical polymerization under high pressure or by polymerization under low pressure in the presence of a Ziegler catalyst; alkylene polymers obtained by thermal decomposition of high-molecular weight alkylene polymers; synthetic hydrocarbon waxes obtained from distillation residues of hydrocarbons obtained by the Arge process from synthetic gases containing carbon monoxide and hydrogen, and synthetic hydrocarbon waxes obtained by hydrogenation of the same; and any of these aliphatic hydrocarbon waxes fractionated by utilizing press sweating, solvent fractionation or vacuum distillation, or by a fractionation crystallization system.

The hydrocarbon, serving as a matrix of the above aliphatic hydrocarbon waxes, may include, e.g., those synthesized by reacting carbon monoxide with hydrogen in the presence of a metal oxide type catalyst (mostly catalysts of a two or more multiple system), as exemplified by hydrocarbons obtained by the Synthol method or the Hydrocol process (making use of a fluidized catalyst bed); hydrocarbons having up to about several hundred carbon atoms, obtained by the Arge process (making use of a fixed catalyst bed) which can obtain waxy hydrocarbons in a large quantity; and hydrocarbons obtained by polymerization of alkylenes such as ethylene in the presence of a Ziegler catalyst. Of these hydrocarbons, in the present invention, they may preferably be less- and small-branched, saturated long straight chain hydrocarbons. In particular, hydrocarbons synthesized by the method not relying on the polymerization of alkylenes are preferred.

As specific examples of the wax usable as the release agent in the present invention, it may include VISCOL (registered trademark) 330-P, 550-P, 660-P, TS-200 (available from Sanyo Chemical Industries, Ltd.); HIWAX 400P, 200P, 100P, 410P, 420P, 320P, 220P, 210P, 110P (available from Mitsui Chemicals, Inc.); SASOL H1, H2, C80, C105, C77 (available from Schumann Sasol Co.); HNP-1, HNP-3, HNP-9, HNP-10, HNP-11, HNP-12 (available from Nippon Seiro Co., Ltd.); UNILIN (registered trademark) 350, 425, 550, 700, UNICID (registered trademark) 350, 425, 550, 700 (available from Toyo-Petrolite Co., Ltd.); and japan wax, bees wax, rice wax, candelilla wax, carnauba wax (available from CERARICA NODA Co., Ltd.).

In the present invention, the polymerization may be carried out by adding a resin to the polymerizable monomer composition. For example, a monomer component containing a hydrophilic functional group such as an amino group, a carboxylic group, a hydroxyl group, a sulfonic acid group, a glycidyl group or a nitrile group, which can not be used because it is water-soluble as a monomer and hence dissolves in an aqueous suspension to cause emulsion polymerization, should be introduced into toner particles, it may be used in the form of a copolymer such as a random copolymer, a block copolymer or a graft copolymer, of any of these with a vinyl compound such as styrene or ethylene, in the form of a polycondensation product such as polyester or polyamide, or in the form of a polyaddition polymer such as polyether or polyimine. Where the high polymer containing such a polar functional group is made present together in the toner particles, the above wax component can be made phase-separated and more strongly enclosed in particles, and hence a magnetic toner can be obtained which has good anti-offset properties, anti-blocking properties and low-temperature fixing performance. Such a high polymer may preferably be used in an amount of from 1 part by mass or more to 20 parts by mass or less based on 100 parts by mass of the polymerizable monomer.

As the high polymer containing such a polar functional group, one having a main-peak molecular weight of 3,000 or more may preferably be used. If it has a main-peak average molecular weight of less than 3,000, especially 2,000 or less, the polymer tends to concentrate in the vicinity of the surfaces of toner particles, and hence it tends to adversely affect developing performance and anti-blocking properties, undesirably. A polymer having a molecular weight different from the range of molecular weight of the toner obtained by polymerizing the polymerizable monomer may also be dissolved in the monomer to carry out polymerization. This enables production of a magnetic toner having a broad molecular weight distribution and high anti-offset properties.

The magnetic toner of the present invention may be mixed in its base particles with a charge control agent in order to stabilize charge characteristics. As the charge control agent, any known agent may be used. In particular, a charge control agent is preferred which affords a high charging speed and can stably maintain a constant charge quantity.

Further, in the case when the toner particles are produced by direct polymerization, particularly preferred are charge control agents having a low polymerization inhibitory action and substantially free of any solubilizate to the aqueous dispersion medium. As specific compounds, a negative charge control agent may include metal compounds of aromatic carboxylic acids such as salicylic acid, alkylsalicylic acids, dialkylsalicylic acids, naphthoic acid and dicarboxylic acids; metal salts or metal complexes of azo dyes or azo pigments; polymer type compounds having a sulfonic acid or carboxylic acid group in the side chain; and boron compounds, urea compounds, silicon compounds, and carixarene. A positive charge control agent may include quaternary ammonium salts, polymer type compounds having such a quaternary ammonium salt in the side chain, guanidine compounds, Nigrosine compounds and imidazole compounds. Any of these charge control agents may preferably be used in an amount of from 0.5 part by mass or more to 10 parts by mass or less based on 100 parts by mass of the binder resin. However, the addition of the charge control agent is not essential in the magnetic toner of the present invention. The triboelectric charging between the toner and the toner layer thickness control member and developer carrying member may actively be utilized to charge the toner electrostatically.

Stated more specifically, those preferable as agents for negative charging may include, e.g., Spilon Black TRH, T-77, T-95 (available from Hodogaya Chemical Co., Ltd.); and BONTRON (registered trademark) S-34, S-44, S-54, E-84, E-88, E-89 (available from Orient Chemical Industries Ltd.). Those preferable as agents for positive charging may include, e.g., TP-302, TP-415 (available from Hodogaya Chemical Co., Ltd.); BONTRON (registered trademark) N-01, N-04, N-07, P-51 (available from Orient Chemical Industries Ltd.), and Copy Blue PR (Klariant GmbH).

In the present invention, the magnetic material particles may be so used as to serve also as a colorant, but a colorant other than the magnetic material particles may also be used in combination. Such a colorant usable in combination may include magnetic or non-magnetic inorganic compounds and known dyes and pigments. Stated specifically, it may include, e.g., ferromagnetic metal particles of cobalt, nickel or the like, or particles of alloys of any of these metals to which chromium, manganese, copper, zinc, aluminum or a rare earth element has been added; as well as hematite particles, titanium black, nigrosine dyes or pigments, carbon black, and phthalocyanine. These may also be used after their particle surface treatment.

In producing the magnetic toner of the present invention by polymerization, a polymerization initiator having a half-life of from 0.5 hour or more to 30 hours or less may be added at the time of polymerization reaction, in an amount of from 0.5 part by mass or more to 20 parts by mass or less based on 100 parts by mass of the polymerizable monomer, to carry out polymerization. This enables production of a polymer having a maximum molecular weight in the region of molecular weight of from 10,000 or more to 100,000 or less, and enables the toner to be endowed with a desirable strength and appropriate melt properties. As example of the polymerization initiator, it may include azo type or diazo type polymerization initiators such as 2,2′-azobis-(2,4-dimethylvaleronitrile), 2,2′-azobisisobutyronitrile, 1,1′-azobis-(cyclohexane-1-carbonitrile), 2,2′-azobis-4-methoxy-2,4-dimethylvaleronitrile and azobisisobutyronitrile; and peroxide type polymerization initiators such as benzoyl peroxide, methyl ethyl ketone peroxide, diisopropyl peroxycarbonate, cumene hydroperoxide, 2,4-dichlorobenzoyl peroxide and lauroyl peroxide.

In the present invention, a cross-linking agent may be added, which may preferably be added in an amount of from 0.001 part by mass or more to 15 parts by mass or less based on 100 parts by mass of the polymerizable monomer.

How to produce the toner particles by a suspension polymerization process that is an example of the direct polymerization is described next. In the suspension polymerization, components necessary as toner particles, such as the magnetic material and optionally the colorant, the release agent, the polymer, a plasticizer, the charge control agent and the cross-linking agent, and other additives as exemplified by an organic solvent used in order to lower the viscosity of a polymer produced by polymerization reaction, a dispersant and so forth are appropriately added to the polymerizable monomer. Thereafter, these are uniformly dissolved or dispersed by means of a dispersion machine such as a homogenizer, a ball mill, a colloid mill or an ultrasonic dispersion machine. The polymerizable monomer composition thus obtained is suspended in an aqueous medium containing a dispersion stabilizer. Here, a high-speed dispersion machine such as a high-speed stirrer or an ultrasonic dispersion machine may be used to make the toner particles have the desired particle size at a stretch. This can more make the resultant toner particles have a sharp particle size distribution. As the time at which the polymerization initiator is added, it may be added simultaneously when other additives are added to the polymerizable monomer, or may be mixed immediately before the polymerizable monomer composition is suspended in the aqueous medium. Also, a polymerization initiator having been dissolved in the polymerizable monomer or in a solvent may be added immediately after granulation and before the polymerization reaction is initiated.

After the granulation, agitation may be carried out using a usual agitator in such an extent that the state of particles is maintained and also the particles can be prevented from floating and settling.

In the suspension polymerization, any known surface-active agent or organic or inorganic dispersant may be used as the dispersion stabilizer. In particular, the inorganic dispersant may hardly cause any ultrafine powder and it attains dispersion stability on account of its steric hindrance. Hence, even when reaction temperature is changed, it may hardly loose the stability and can be washed with ease, and hence it may preferably be used. As examples of such an inorganic dispersant, it may include phosphoric acid polyvalent metal salts such as calcium phosphate, magnesium phosphate, aluminum phosphate and zinc phosphate; carbonates such as calcium carbonate and magnesium carbonate; inorganic salts such as calcium metasilicate, calcium sulfate and barium sulfate; and inorganic oxides such as calcium hydroxide, magnesium hydroxide, aluminum hydroxide, silica, bentonite and alumina.

When these inorganic dispersants are used, they may be used as they are. In order to obtain finer particles, particles of the inorganic dispersant may be formed in the aqueous medium. For example, in the case of calcium phosphate, an aqueous sodium phosphate solution and an aqueous calcium chloride solution may be mixed under high-speed agitation, whereby water-insoluble calcium phosphate can be formed and more uniform and finer dispersion can be made. Here, water-soluble sodium chloride is simultaneously formed as a by-product. However, the presence of such a water-soluble salt in the aqueous medium keeps the polymerizable monomer from dissolving in water to make any ultrafine toner particles not easily formed by emulsion polymerization, and hence this is more favorable. Since, however, this water-soluble sodium chloride may be an obstacle when residual polymerizable monomers are removed at the termination of polymerization reaction, it is better to exchange the aqueous medium or desalt it with an ion-exchange resin. The inorganic dispersant can substantially completely be removed by dissolving it with an acid or an alkali after the polymerization is completed.

Any of these inorganic dispersants may preferably be used in an amount of from 0.2 part by mass or more to 20 parts by mass or less based on 100 parts by mass of the polymerizable monomer. Where toner particles made more fine-particle, for example, toner particles of 5 μm or less in average particle diameter are intended, a surface-active agent may be used in combination in an amount of from 0.001 part by mass or more to 0.1 part by mass or less based on 100 parts by mass of the polymerizable monomer.

Such a surface-active agent may include, e.g., sodium dodecylbenzenesulfate, sodium tetradecyl sulfate, sodium pentadecyl sulfate, sodium octyl sulfate, sodium oleate, sodium laurate, sodium stearate and potassium stearate.

In the step of polymerization, the polymerization may be carried out at a polymerization temperature set at 40° C. or above, and commonly at a temperature of from 50° C. or more to 90° C. or less. When polymerization is carried out within this temperature range, the release agent comes enclosed more favorably. In order to consume residual polymerizable monomers, the reaction temperature may be raised to from 90° C. or more to 150° C. or less at the termination of polymerization reaction. This is also a preferable method.

Where the magnetic toner of the present invention is produced by a pulverization process, a known method may be used. For example, the binder resin, the magnetic material and optionally other additives are thoroughly mixed by means of a mixing machine such as Henschel mixer or a ball mill, then the mixture obtained is melt-kneaded by means of a heat kneading machine such as a kneader or an extruder to make resins melt one another, the melt-kneaded product obtained is cooled to solidify, thereafter the solidified product is pulverized, and the pulverized product is classified to obtain toner particles. The toner particles (toner base particles) thus obtained and an external additive(s) such as a fluidity improver described later may optionally be mixed by means of a mixing machine such as Henschel mixer to obtain the magnetic toner.

Examples of apparatus commonly usable for the production of the toner by pulverization are given below. Examples, however, are by no means limited to these. Examples of Pulverizer for Toner Production, Examples of Classifier for Toner Production, Examples of Sifter for Toner Production, Examples of Mixing Apparatus for Toner Production and Examples of Kneading Apparatus for Toner Production are given in Tables 1, 2, 3, 4 and 5, respectively.

TABLE 1
Examples of Pulverizer for Toner Production

| Name of apparatus | Manufacturer |
|---|---|
| Counter Jet Mill | Hosokawa Micron Corporation |
| Micron Jet | Hosokawa Micron Corporation |
| IDS-type Mill | Nippon Pneumatic MFG. Co., Ltd. |
| PJM Jet Grinding Mill | Nippon Pneumatic MFG. Co., Ltd. |
| Cross Jet Mill | Kurimoto, Ltd. |
| Ulmax | Nisso Engineering Co., Ltd. |
| SK Jet O-Mill | Seishin Enterprise Co., Ltd. |
| Criptron | Kawasaki Heavy Industries, Ltd. |
| Turbo Mill | Turbo Kogyo Co., Ltd. |
| Inomizer | Hosokawa Micron Corporation |

TABLE 2
Examples of Classifier for Toner Production

| Name of apparatus | Manufacturer |
|---|---|
| Classyl | Seishin Enterprise Co., Ltd. |
| Micron Classifier | Seishin Enterprise Co., Ltd. |
| Spedic Classifier | Seishin Enterprise Co., Ltd. |
| Turbo Classifier | Nisshin Engineering Inc. |
| Micron Separator | Hosokawa Micron Corporation |
| Turboprex(ATP) | Hosokawa Micron Corporation |
| TSP Separator | Hosokawa Micron Corporation |
| Elbow-Jet | Nittestsu Mining Co., Ltd. |
| Dispersion Separator | Nippon Pneumatic MFG. Co., Ltd. |
| YM Microcut | Yasukawa Shoji K.K. |

TABLE 3
Examples of Sifter for Toner Production

| Name of apparatus | Manufacturer |
|---|---|
| Ultrasonics | Koei Sangyo Co., Ltd. |
| Rezona Sieve | Tokuju Corporation |
| Vibrasonic Sifter | Dulton Company Limited |
| Sonicreen | Shinto Kogio Co., Ltd. |
| Gyro Sifter | Tokuju Corporation |
| Circular vibration sifters | many manufacturers |
| Turbo-Screener | Turbo Kogyo Co., Ltd. |
| Microsifter | Makino mfg. co., ltd. |

TABLE 4
Examples of Mixing Apparatus for Toner Production

| Name of apparatus | Manufacturer |
|---|---|
| Henschel Mixer | Mitsui Mining and Smelting Co., |
| | Ltd. |
| Super Mixer | Kawata MFG Co., Ltd. |
| Conical Ribbon Mixer | Y.K. Ohkawara Seisakusho |
| Nauta Mixer | Hosokawa Micron Corporation |
| Spiral Pin Mixer | Pacific Machinery and |
| | Engineering Co., Ltd. |
| Rhedige Mixer | Matsubo Corporation |
| Turbulizer | Hosokawa Micron Corporation |
| Cyclomix | Hosokawa Micron Corporation |

TABLE 5
Examples of Kneading Apparatus for Toner Production

| Name of apparatus | Manufacturer |
|---|---|
| KRC Kneader | Kurimoto, Ltd. |
| Buss Kneader | Coperion Buss Ag. |
| TEM-type Extruder | Toshiba Machine Co., Ltd. |
| TEX Twin-screw Extruder | The Japan Steel Works, Ltd. |
| PCM Kneader | Ikegai, Ltd. |
| Three-Roll Mill | Inoue Manufacturing Co., Ltd. |
| Mixing Roll Mill | Inoue Manufacturing Co., Ltd. |
| Kneader | Inoue Manufacturing Co., Ltd. |
| Kneadex | Mitsui Mining and Smelting |
| | Co., Ltd. |
| MS-type Pressure Kneader | Moriyama Manufacturing Co., |
| | Ltd. |
| Kneader-Ruder | Moriyama Manufacturing Co., |
| | Ltd. |
| Banbury Mixer | Kobe Steel, Ltd. |

In the present invention, in order to control the circularity of the toner, it is preferable to pulverize toner particles by a method in which mechanical impact is applied. As treatment in which the mechanical impact is applied, available are, e.g., a method making use of a mechanical pulverizer such as KTM, a pulverizer manufactured by Kawasaki Heavy Industries, Ltd., or Turbo mill, manufactured by Turbo Kogyo Co., Ltd., and a method of making treatment by means of an apparatus such as a mechanofusion system manufactured by Hosokawa Micron Corporation, or a hybridization system manufactured by Nara Machinery Co., Ltd. These apparatus may be used as they are, or may be used after their appropriate improvement. The controlling of conditions in applying such mechanical impact enables control of the circularity of the toner.

In producing the magnetic toner of the present invention, the classification may be carried out at any time after the formation of toner base particles. For example, the classification may be carried out after the toner base particles have been mixed with the external additive(s).

The magnetic toner of the present invention is used in the state that various materials according to the type of the toner are externally added to the toner base particles. As materials to be externally added, they may include, e.g., a fluidity improver for improving the fluidity of the toner, such as an inorganic fine powder, and a conductive fine powder for controlling the chargeability of the toner, such as fine metal oxide particles.

The fluidity improver may include those which can improve the fluidity of the magnetic toner by its external addition to the toner base particles. Such a fluidity improver may include, e.g., fine silica powders such as wet-process silica and dry-process silica, as well as fine titanium oxide powder and fine alumina powder; and treated silica powder, treated titanium oxide powder and treated alumina powder which are obtained by subjecting the above powders to surface treatment with a silane coupling agent, a titanium coupling agent, a silicone oil or the like.

It is preferable for the fluidity improver to have a specific surface area of 30 m²/g or more as measured by the BET method, utilizing nitrogen gas absorption, and more preferably have a specific surface area of 50 m²/g or more. The fluidity improver may preferably be mixed in an amount of, e.g., which may differ depending on the type of the fluidity improver, from 0.01 part by mass or more to 8 parts by mass or less, and more preferably from 0.1 part by mass or more to 4 parts by mass or less, based on 100 parts by mass of the toner base particles.

A preferred fluidity improver is a fine powder produced by vapor phase oxidation of a silicon halide, which is called dry-process silica or fumed silica. For example, such silica is one which utilizes, e.g., heat decomposition oxidation reaction in oxygen-and-hydrogen of silicon tetrachloride gas. The reaction basically proceeds in the following scheme (3) as shown below:

SiCl₄+2H₂+O₂→SiO₂+4HCl (3)

In this production step, it is also possible to use other metal halide such as aluminum chloride or titanium chloride together with the silicon halide to obtain a composite fine powder of silica with other metal oxide. The fine silica powder used as the fluidity improver in the present invention includes such a composite fine powder as well. As to its particle diameter, it may preferably have average primary particle diameter within the range of from 0.001 μm or more to 2 μm or less, and particularly preferably within the range of from 0.002 μm or more to 0.2 μm or less.

Commercially available fine silica powders produced by the vapor phase oxidation of silicon halides may include, e.g., those which are on the market under the following trade names, i.e., AEROSIL 130, 200, 300, 380, TT600, MOX170, MOX80, COK84 (Aerosil Japan, Ltd.); Ca-O-SiL M-5, MS-7, MS-75, HS-5, EH-5 (CABOT Co.); WACKER HDK N20, V15, N20E, T30, T40 (WACKER-CHEMIE GMBH); D-C Fine Silica (Dow-Corning Corp.); and FRANSOL (Franzil Co.).

In the present invention, it is preferable for the fine silica powder to have been subjected to hydrophobic treatment. The fine silica powder may be fine silica powder having been so treated that its hydrophobicity as measured by a methanol titration test shows a value within the range of from 30 degrees or more to 80 degrees or less. Such a fine silica powder is particularly preferred in order to bring out toner physical properties that are stable to any environmental variations. The hydrophobicity is expressed as percentage of methanol in a liquid mixture of methanol and water, formed when methanol is dropwise added to a stated quantity of fine silica powder kept stirred in water and the fine silica powder has finished settling.

As a method for making the fine silica powder hydrophobic, a method is available in which, e.g., the fine silica powder is chemically treated with an organosilicon compound or silicone oil capable of reacting with the fine silica powder or physically adsorptive on fine silica particles. Preferred is hydrophobic treatment with an organosilicon compound. Herein, the organosilicon compound may include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, dimethyldimethoxysilane, diphenyldiethoxysilane, hexamethyldisiloxane, 1,3-divinyltetramethyldisiloxane, 1,3-diphenyltetramethyldisiloxane, and a dimethylpolysiloxane having 2 to 12 siloxane units per molecule and having a hydroxyl group bonded to each Si in its units positioned at the terminals. Any of these may be used alone or in the form of a mixture of two or more types.

In the hydrophobic treatment of the fine silica powder, among the above organosilicon compounds, one or two or more types of silane coupling agents further having a nitrogen atom may be used. Such a nitrogen-containing silane coupling agent may include, e.g., aminopropyltrimethoxysilane, aminopropyltriethoxysilane, dimethylaminopropyltrimethoxysilane, diethylaminopropyltrimethoxysilane, dipropylaminopropyltrimethoxysilane, dibutylaminopropyltrimethoxysilane, monobutylaminopropyltrimethoxysilane, dioctylaminopropyldimethoxysilane, dibutylaminopropylmethyldimethoxysilane, dibutylaminopropylmonomethoxysilane, dimethylaminophenyltriethoxysilane, trimethoxylsilyl-γ-propylphenylamine, and trimethoxylsilyl-γ-propylbenzylamine.

In the present invention, as a preferred silane coupling agent, it may include hexamethyldisilazane (HMDS).

As the silicone oil that may also preferably be used for the hydrophobic treatment of the fine silica powder, it may preferably have a viscosity at 25° C. of from 0.5 mm²/s or more to 10,000 mm²/s or less, more preferably from 1 mm²/s or more to 1,000 mm²/s or less, and still more preferably from 10 mm²/s or more to 200 mm²/s or less. As a particularly preferred silicone oil, it may include, e.g., dimethylsilicone oil, methylphenylsilicone oil, α-methylstyrene modified silicone oil, chlorophenylsilicone oil, and fluorine modified silicone oil.

As methods for the fine silica powder surface hydrophobic treatment making use of the silicone oil, available are, e.g., a method in which the fine silica powder treated with a silane coupling agent and the silicone oil are directly mixed by means of a mixing machine such as Henschel mixer; a method in which the silicone oil is sprayed on the fine silica powder serving as a base; and a method in which the silicone oil is first dissolved or dispersed in a suitable solvent, and then the fine silica powder is added thereto, followed by removal of the solvent.

In the case when the surface hydrophobic treatment of the fine silica powder is carried out using the silicone oil, it is more preferable that the fine silica powder having been treated with the silicone oil is heated to 200° C. or more (preferably 250° C. or more) in an inert gas to make surface coatings stable.

In the present invention, both the silane coupling agent and the silicone oil as described above may be used in the surface hydrophobic treatment of the fine silica powder. As methods for such surface hydrophobic treatment, available are a method in which the fine silica powder is beforehand treated with the silane coupling agent and thereafter treated with the silicone oil, and a method in which the fine silica powder is simultaneously treated with the silane coupling agent and the silicone oil.

An external additive other than the fluidity improver may further optionally be added to the magnetic toner of the present invention.

For example, in order to, e.g., improve cleaning performance, preferred are fine particles having a primary particle diameter of more than 30 nm, and more preferably inorganic fine particles having a primary particle diameter of 50 nm or more and being closely spherical. Such inorganic fine particles may preferably have a BET specific surface area of less than 50 m²/g, and more preferably less than 30 m²/g. Instead, organic fine particles may further be added to the toner base particles. This is also one of preferred embodiments. For example, it is preferable to use spherical silica particles, spherical polymethyl silsesquioxane particles or spherical resin particles.

Other additives may further be used, which may include, e.g., lubricant powders such as polyethylene fluoride powder, zinc stearate powder and polyvinylidene fluoride powder; abrasives such as cerium oxide powder, silicon carbide powder and strontium titanate powder; anti-caking agents; or conductivity-providing agents such as carbon black powder, zinc oxide powder and tin oxide powder. Reverse-polarity organic particles and inorganic particles may also be added as developability improvers in a small quantity. These additives may also be used after hydrophobic treatment of their particle surfaces.

Such external additives other than the fluidity improver as described above may each be used in an amount of from 0.1 part by mass or more to 5 parts by mass or less, and preferably from 0.1 part by mass or more to 3 parts by mass or less, based on 100 parts by mass of the toner base particles.

An image forming method in which the magnetic toner of the present invention may be used is described next.

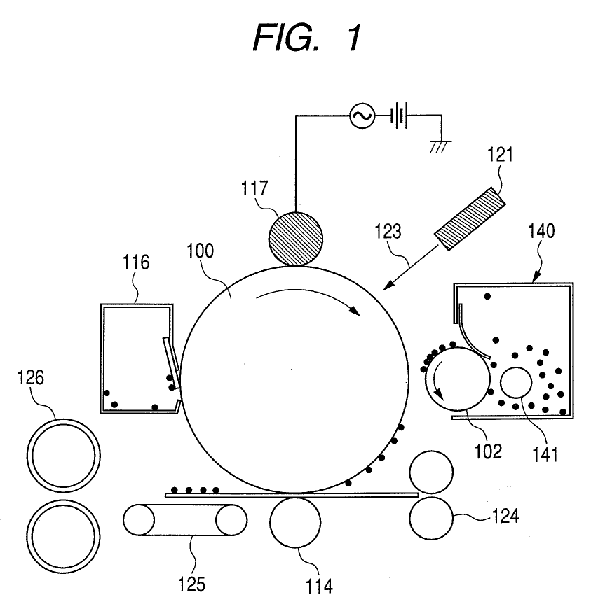

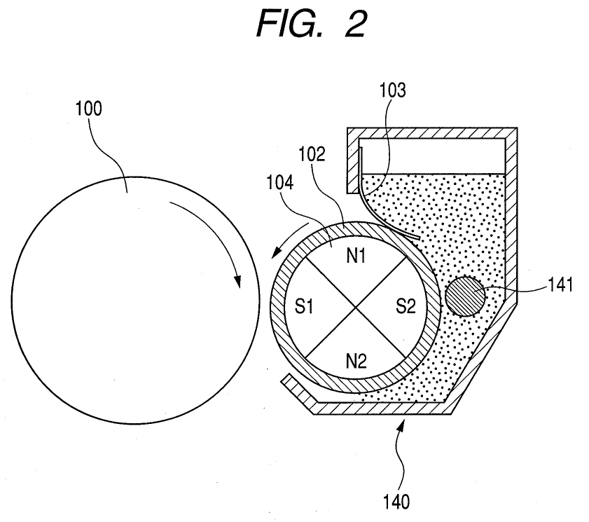

FIG. 1 is a diagrammatic sectional view showing the construction of an image forming apparatus. FIG. 2 is a diagrammatic sectional view showing the construction of the part of a developing assembly in FIG. 1. The image forming apparatus shown in the drawings is an electrophotographic apparatus employing a developing system making use of a one-component developer magnetic toner. Reference numeral 100 denotes an electrostatic latent image bearing member (photosensitive drum), around which provided are a primary charging roller 117, a developing assembly 140, a transfer charging roller 114, a cleaner 116, a registration roller 124 and so forth. The photosensitive drum 100 is electrostatically charged to, e.g., −700 V by means of the primary charging roller 117 (applied voltage: AC voltage Vpp of 2.0 kV, DC voltage Vdc of −700 V). Then the photosensitive drum 100 is exposed by irradiating it with laser light 123 by means of a laser generator 121, thus an electrostatic latent image corresponding to an image to be formed is formed on the photosensitive drum 100. The electrostatic latent image formed on the photosensitive drum 100 is developed with the one-component magnetic developer by means of the developing assembly 140 to form a toner image, which is then transferred to a transfer material by means of the transfer roller 114, which is brought into contact with the photosensitive drum via the transfer material. The transfer material holding the toner image thereon is transported to a fixing assembly 126 by a transport belt 125, and the toner image is fixed onto the transfer material. Some toner remaining on the photosensitive drum is removed by the cleaning means 116 to clean the surface of the former.

The developing assembly 140 has, as shown in FIG. 2, a cylindrical toner carrying member (hereinafter “developing sleeve”) 102 made of a non-magnetic metal such as aluminum or stainless steel, in the state it is in proximity to the photosensitive drum 100. A gap between the photosensitive drum 100 and the developing sleeve 102 is maintained at a stated distance (e.g., about 300 μm) by the aid of a sleeve-to-photosensitive drum gap retaining member (not shown) In the interior of the developing sleeve 102, a magnet roller 104 is stationarily so provided as to be concentric to the developing sleeve 102. However, the developing sleeve 102 is rotatable. The magnet roller 104 has a plurality of magnetic poles as shown in the drawing, where S1 operates on development; N1, control of toner coat level; S2, take-in and transport of the toner; and N2, prevention of the toner from spouting. The toner is coated on the developing sleeve 102 by a toner coating roller 141, and is transported adhering thereto. As a member which controls the level of the toner thus transported, an elastic blade 103 is provided. The level of the toner to be transported to a developing zone is controlled by the pressure at which the elastic blade 103 comes into touch with the developing sleeve 102. In the developing zone, DC and AC developing biases are applied across the photosensitive drum 100 and the developing sleeve 102, and the developer on the developing sleeve flies onto the photosensitive drum 100 in accordance with the electrostatic latent image to come into a visible image.

How to measure physical properties in the present invention are describe below in detail.

(1) Measurement of Weight Average Particle Diameter (D4)

About particle size distribution, it may be measured by various methods. In the present invention, it is measured with Coulter Counter Multisizer.

Coulter Counter Multisizer Model II (manufactured by Coulter Electronics, Inc.) is used as a measuring instrument. An interface (manufactured by Nikkaki Bios Co.) that outputs number distribution and volume distribution and a computer for analysis are connected thereto. As an electrolytic solution, an aqueous 1% NaCl solution is prepared using special-grade or first-grade sodium chloride. As a method for measurement, 5 ml of a surface-active agent (preferably an alkylbenzene sulfonate) is added as a dispersant to 150 ml of the above aqueous electrolytic solution, and 20 mg of a sample to be measured is further added. The electrolytic solution in which the sample has been suspended is subjected to dispersion treatment for 3 minutes in an ultrasonic dispersion machine. When the particle diameter of the toner is measured with the above Coulter Counter Multisizer Model II, an aperture of 100 μm in size is used to make measurement. On the basis of the values obtained, the weight average particle diameter (D4) is calculated.

(2) Measurement of Average Circularity of Toner

The average circularity of the toner is measured with a flow type particle image analyzer “FPIA-2100” (manufactured by Sysmex Corporation). Details are as follows.

First, circularity is calculated according to the following expression.

Circularity=(circumferential length of a circle with the same area as particle projected area)/(circumferential length of particle projected image).

Herein, the “particle projected area” is defined as the area of a binary-coded toner particle image, and the “circumferential length of particle projected image” is defined as the length of a contour line formed by connecting edge points of the toner particle image. In the measurement, used is the circumferential length of a particle image in image processing at an image processing resolution of 512×512 (a pixel of 0.3 μm×0.3 μm).

The circularity referred to in the present invention is an index showing the degree of surface unevenness of particles. It is indicated as 1.00 when the particles are perfectly spherical. The more complicate the surface shape is, the smaller the value of circularity is.

Average circularity C which means an average value of circularity frequency distribution is calculated from the following expression (1) where the circularity at a partition point i of particle size distribution is represented by ci, and the number of particles measured by m.

$$Average circularity C = \text{:} {\sum }_{i = 1}^{m} ci / m \qquad ( 1 )$$

As a specific way of measurement, 10 ml of ion-exchanged water from which impurity solid matter or the like has beforehand been removed is made ready in a container, and a surface active agent, preferably sodium dodecylbenzenesulfonate, is added thereto as a dispersant. Thereafter, a sample for measurement is further added in an amount of 0.02 g, and is uniformly dispersed. As a means for dispersing it, an ultrasonic dispersion machine “TETORA Model 150” (manufactured by Nikkaki Bios Co., Ltd.), which incorporates two oscillators having an oscillation frequency of 50 kHz in a state that the phases are 180° shifted and has an electric output of 120 W, is used, and dispersion treatment is carried out for 2 minutes to prepare a liquid dispersion for measurement. In that course, the liquid dispersion is appropriately cooled so that its temperature does not come to 40° C. or more. Also, in order to keep the circularity from scattering, the flow type particle image analyzer FPIA-2100 is installed in an environment controlled to 23° C.±0.5° C. so that its in-machine temperature can be kept at 26° C. or more to 27° C. or less. Further, autofocus control is performed using 2 μm latex particles at intervals of constant time, and preferably at intervals of 2 hours.

In measuring the circularity of the toner particles, the above flow type particle analyzer is used and the concentration of the liquid dispersion is again so controlled that the toner particle concentration at the time of measurement may be 5,000 particles/μl, to make measurement. After the measurement, using the data obtained, the data of particles with a circle-equivalent diameter of less than 2 μm are cut, and the average circularity of the toner particles is determined. Here, the circle-equivalent diameter is the value calculated according to the following expression.

Circle-equivalent diameter=(particle projected area/π)^{1/2}×2.

The measuring instrument “FPIA-2100” used in the present invention is, compared with “FPIA-1000” having ever been used to observe the shape of toner particles, an instrument having succeeded in making its sheath flow more thin-layer (7 μm→4 μm) and improved in magnification of processed particle images. It is an instrument having been further improved in processing resolution of images captured (256×256→512×512), and is an instrument having been improved in precision of measurement of toner particle shapes.

(3) Measurement of Dissolution Level of Magnetic Material

In the present invention, the dissolution level of magnetic material that is found when the magnetic toner is dispersed in 5 mol/liter hydrochloric acid is measured in the following way.

1) 25 mg of the toner is precisely weight for four samples each.

2) The samples are put into sample bottles to ready four samples in which 100 ml of 5 mol/liter hydrochloric acid has been added. The respective samples are stirred with stirrers, during which the samples are subjected to dispersion for 3 minutes, for 15 minutes, for 30 minutes and overnight (for 24 hours), respectively, to dissolve the magnetic material to effect extraction.

3) After lapse of the stated time, the solutions obtained as a result of dissolution are each immediately filtered with a sample-treating filter (pore size: from 0.2 μm or more to 0.5 μm or less; e.g., MAISHORIDISK H-25-5, available from Tosoh Corporation, may be used). Thereafter, for each filtrate formed, its absorbance at a wavelength of 338 nm is measured with a spectrophotometer (e.g., UV-3100PC, manufactured by Shimadzu Corporation). Here, 10 mol/liter of hydrochloric acid in which the toner is not dissolved is kept put into a control cell. The absorbance is expressed as the common logarithm of a reciprocal of light transmittance I/I₀ which is the ratio of incident-light intensity I₀ to transmitted-light intensity I measured when light is made incident on the sample cell, i.e., log(I/I₀).

Conditions for Measurement

Scanning speed: Medium speed.
Slit width: 0.5 nm.
Sampling pitch: 2 nm.
Measurement range: 600 nm to 250 nm.

The dissolution percentages of the magnetic material with respect to the total content of the magnetic material at a point of time of 3 minutes, at a point of time of 15 minutes and at a point of time of 30 minutes are calculated according to the proportion of the absorbance at a wavelength of 338 nm of the filtrates of the samples having been subjected to the extraction for 3 minutes, 15 minutes and 30 minutes each to the absorbance at a wavelength of 338 nm of the filtrate of the sample having been left to stand overnight (in which the magnetic material has completely been dissolved).

(4) Measurement of Particle Diameter of Magnetic Material

The number average particle diameter of the magnetic material is measured with a laser diffraction particle size distribution meter (manufactured by Horiba Ltd.).

(5) Measurement of dielectric loss factor of toner: The magnetic toner is weighed in an amount of 1 g, which is then molded into a disk-like measuring sample of 25 mm in diameter and 1.5±0.5 mm in thickness under application of a load of 20 kPa for 1 minute.

This measuring sample is fitted to ARES (manufactured by TA Instruments Co.) fitted with a dielectric constant measuring jig (electrode) of 25 mm in diameter, and complex dielectric constant at a frequency of 1.0×10⁴ Hz is measured with 4284A Precision LCR Meter (manufactured by Hewlett-Packard Co.) in the state a load of 250 g/cm² is applied to the sample at 25° C. From the measured value found, dielectric loss factor (tan δ=∈″/∈′) is calculated.

### EXAMPLES

The present invention is described below in greater detail by giving production examples and working examples, which, however, by no means limit the present invention. In the following formulation, “part(s)” refers to part(s) by mass in all occurrences.

### Production Example 1 of Magnetic Iron Oxide

In an aqueous ferrous sulfate solution, a sodium hydroxide solution (containing 1% by mass of sodium hexametaphosphate in terms of P based on Fe) was mixed in an equivalent weight of from 1.0 or more to 1.1 or less based on iron ions, to prepare an aqueous solution which contained ferrous hydroxide. Maintaining the pH of the aqueous solution at 9, air was blown into it to effect oxidation reaction at 80° C. or more to 90° C. or less to prepare a slurry fluid from which seed crystals were to be formed.

Next, to this slurry fluid, an aqueous ferrous sulfate solution was so added as to be in an equivalent weight of from 0.9 or more to 1.2 or less based on the initial alkali content (the sodium component in the sodium hydroxide). Thereafter, maintaining the pH of the slurry fluid at 8, oxidation reaction was carried on while air was blown into it. At the termination of the oxidation reaction, the pH was adjusted to about 6, and then as silane coupling agents n-C₄H₉Si(OCH₃)₃ and n-C₈H₁₇Si(OC₂H₅)₃ were added thereto in an amount of 0.6 part and 0.9 part, respectively, based on 100 parts by mass of the magnetic iron oxide, followed by thorough stirring. The hydrophobic iron oxide particles thus formed were washed, filtered and then dried by conventional methods, followed by disintegration treatment of particles standing agglomerate, to obtain Magnetic Iron Oxide 1. This Magnetic Iron Oxide 1 was 0.25 μm in number average particle diameter, and 68.6 Am²/kg and 3.7 Am²/kg in magnetization intensity and residual magnetization, respectively, when magnetized in a magnetic field of 79.6 kA/m (1,000 oersteds).

### Production Examples 2 to 9 of Magnetic Iron Oxide

Magnetic Iron Oxides 2 to 9 were obtained in the same way as the above except that, as shown in Table 6, the type(s) of the treating(s) was/were changed and added in the amount(s) shown therein. Physical properties of the magnetic iron oxides obtained are shown in Table 6.

### Production Example 10 of Magnetic Iron Oxide

Magnetic Iron Oxide 10 as shown in Table 6 was obtained in the same way as in Magnetic Iron Oxide Production Example 1 except that no silane coupling was added.

### Production of Magnetic Toner 1

Into 709 parts by mass of ion-exchanged water, 451 parts of an aqueous 0.1 mol/liter Na₃PO₄ solution was introduced, followed by heating to 60° C. Thereafter, 67.7 parts of an aqueous 1.0 mol/liter CaCl₂ solution was slowly added thereto to obtain an aqueous medium containing Ca₃(PO₄)₂.

Meanwhile, materials formulated as below were uniformly dispersed and mixed by means of an attritor (manufactured by Mitsui Miike Engineering Corporation).

| | |
|---|---|
| Styrene | 74 parts |
| n-Butyl acrylate | 26 parts |
| Saturated polyester resin | 3 parts |

(monomer make-up: bisphenol-A propylene oxide addition product/terephthalic acid/isophthalic acid; acid value: 12 mgKOH/g; Tg (glass transition temperature): 69° C.; Mn (number-average molecular weight): 4,200; Mw (weight-average molecular weight): 11,000)

| | |
|---|---|
| Negative charge control agent | 2 parts |
| (T-77, a monoazo dye type Fe compound available from | |
| Hodogaya Chemical Co., Ltd.) | |
| Magnetic Iron Oxide 1 | 90 parts |

In regard to the magnetic iron oxide, it was disintegrated by means of a ball mill as pretreatment before it was mixed with the other materials. Also, at the time of dispersing and mixing, the value of C/E that is the proportion of the average feed rate C (kg/s) of Magnetic Iron Oxide 1 to the mass E (kg) of the polymerizable monomer, was controlled to be 2.7×10⁻⁴.

A mixture of these was heated to 60° C., and 10 parts of hydrocarbon wax (C105, available from Schumann Sasol Co.; DSC endothermic main peak: 105° C.) was mixed and dissolved therein. In the mixture obtained, 2 parts of butyl peroxide was dissolved as a polymerization initiator to obtain a polymerizable monomer composition.

This polymerizable monomer composition was introduced into the above aqueous medium, and these were stirred at 60° C., and for 15 minutes at 12,000 rpm by means of CLEAMIX (manufactured by M_{TECHNIQUE} Co., Ltd.) in an atmosphere of N₂ to carry out granulation. Thereafter, the granulated product obtained was stirred with a paddle stirring blade, during which the reaction was carried out at 80° C. for 1 hours. Thereafter, the stirring was further continued for 10 hours keeping the liquid temperature at 80° C. After the reaction was completed, the suspension formed was cooled, where hydrochloric acid was added thereto to dissolve the Ca₃ (PO₄)₂, followed by filtration, water washing and then drying to obtain toner particles.

100 parts of the toner base particles thus obtained and 1.2 parts of hydrophobic fine silica powder treated with hexamethyldisilazane and thereafter further treated with silicone oil and having a BET specific surface area of 140 m²/g after treatment were mixed by means of Henschel mixer (manufactured by Mitsui Miike Engineering Corporation) to obtain Magnetic Toner 1 (weight average particle diameter: 6.5 μm). Physical properties of Magnetic Toner 1 are shown in Table 8.

### Production Examples of Magnetic Toners 2-9

Magnetic Toners 2 to 9 were obtained in the same way as in Production Example of Magnetic Toner 1 except that, in Production Example of Magnetic Toner 1, the type of the magnetic iron oxide and the value of C/E representing the feed rate of magnetic material were changed. Conditions for producing Magnetic Toners 2 to 9 are shown in Table 7. Physical properties of Magnetic Toners 2 to 9 are also shown in Table B.

### Production Examples of Comparative Magnetic Toners 1-3 and 6-9

Comparative Magnetic Toners 1 to 3 and 6 to 9 were obtained in the same way as in Production Example of Magnetic Toner 1 except that, in Production Example of Magnetic Toner 1, the type of the magnetic iron oxide, whether or not the step of disintegrating the magnetic material was taken, and the value of C/E representing the feed rate of magnetic material were changed. Conditions for producing Comparative Magnetic Toners 1 to 3 and 6 to 9 are shown in Table 7. Physical properties of Comparative Magnetic Toners 1 to and 6 to 9 are also shown in Table 8.

### Production Example of Comparative Magnetic Toner 4

Comparative Magnetic Toner 4 was obtained in the same way as in Production Example of Magnetic Toner 1 except that, in Production Example of Magnetic Toner 1, 0.1 part of the following polar compound was added. Physical properties of Comparative Magnetic Toner 4 are shown in Table 8.

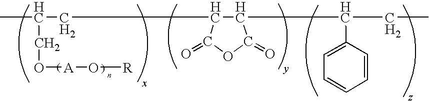

(a compound of n=9; x:y:z=50:40:10; A: —CH₂CH₂—; R: a methyl group; and peak molecular weight (Mp): 3,000)

### Production Example of Comparative Magnetic Toner 5

| | |
|---|---|
| Binder resin | 100 parts |
| (a copolymer composed of styrene and 2-ethylhexyl | |
| acrylate; Mw: 260,000; Mn: 15,000) | |
| Magnetic Iron Oxide 10 | 90 parts |
| Negative charge control agent | 2 parts |
| (T-77, a monoazo dye type Fe compound available from | |
| Hodogaya Chemical Co., Ltd.) | |
| Hydrocarbon wax | 3 parts |
| (C105, available from Schumann Sasol Co.; DSC | |
| endothermic main peak: 105° C.) | |

The above materials were mixed for 3 minutes by means of Henschel mixer, and thereafter the mixture obtained was melt-kneaded by means of a twin-screw extruder PCM-30 heated to 160° C. The kneaded product obtained was cooled using a cooling belt (cooling water: 15° C.) and the kneaded product cooled was crushed by using a hammer mill. The crushed product obtained was finely pulverized by means of Turbo mill (manufactured by Turbo Kogyo Co., Ltd.). The finely pulverized product thus obtained was classified by means of an air classifier to obtain Comparative Magnetic Toner 5, having a weight average particle diameter of 6.3 μm.

### Example 1

Using Magnetic Toner 1, the following evaluation was made. The results of evaluation are shown in Table 9.

As an image forming apparatus, LBP3000 (14 sheets/minute; manufactured by CANON INC.) was used which was converted to have a process speed of 240 mm/sec. In a high-temperature and high-humidity environment (32.5° C./80% RH), horizontal-line images having a print percentage of 3% were reproduced on 2,000 sheets in an intermittent mode to conduct a running test. Letter paper (75 g/m²) available from Xerox Corporation was used as recording mediums.

Image Density

After the images were reproduced on 2,000 sheets, a solid image was formed, and the density of this solid image was measured with Macbeth densitometer (manufactured by Gretag Macbeth Ag).

A: 1.40 or more.
B: 1.35 or more to less than 1.40.
C: 1.30 or more to less than 1.35.
D: Less than 1.30.

### Dot Reproducibility

After the images were reproduced on 2,000 sheets, an isolated one-dot halftone pattern was printed, and the reproducibility of dots was judged through organoleptic evaluation made by visual observation using an optical microscope, and according to the following judgment criteria.

A: Edges of dots are sharp, and toner spots around dots are little seen.
B: Edges of dots are sharp, but toner spots around dots are a little seen.
C: Toner spots around dots are a little much seen, and edges are not sharp.
D: Below the level of “C”.

Low-Temperature Cardboard Fog

Low-temperature cardboard fog refers to the evaluation on fog that is made under conditions easily causative of fog where a test is conducted in a low-temperature environment (10° C./10% RH) and using cardboard (letter paper available from Xerox Corporation: 105 g/m²).

Using the above image forming apparatus and in a low-temperature and low-humidity environment (10° C./10% RH), horizontal-line images having a print percentage of 3% were reproduced on 50 sheets in an intermittent mode. Next, white images were reproduced on 2 sheets, which were reproduced in a double-side mode only on the 2nd sheet. About the back-side white image on the 2nd sheet, its reflectance was measured with REFLECTOMETER MODEL TC-6DS, manufactured by Tokyo Denshoku Co., Ltd., which was measured at 5 spots and the values found were averaged.

Meanwhile, the reflectance was also measured in the same way on a transfer sheet before the white image was formed thereon. A green filter was used as a filter. From the values of reflectance before and after the white-image reproduction, fog was calculated by using the following expression.

Fog (%)=reflectance (%) of transfer sheet−reflectance (%) of white-image sample.

Fog

After the running test was finished, white images were reproduced, and the reflectance thereof was measured with REFLECTOMETER MODEL TC-6DS, manufactured by Tokyo Denshoku Co., Ltd. Meanwhile, the reflectance was also measured in the same way on a transfer sheet before the white image was formed thereon. A green filter was used as a filter. From the values of reflectance before and after the white-image reproduction, fog was calculated by using the following expression.

Fog (%)=reflectance (%) of transfer sheet−reflectance (%) of white-image sample.

Fixing Test

Using the LBP-3000 conversion machine set as above, a fixing test was also conducted in a normal-temperature and normal-humidity environment (23° C./60% RH).

First, halftone toner images were so formed on FOX RIVER BOND Paper as to be from 0.75 or more to 0.80 or less in image density, and were fixed setting the fixing assembly at a temperature of 150° C. which was made higher therefrom at intervals of 5° C. Thereafter, fixed images were rubbed 10 times with Silbon paper under application of a load of 55 g/cm², where the rate of decrease in image density before and after the rubbing came to 10% or less was regarded as fixing start temperature.

As the result, the fixing start temperature of Magnetic Toner 1 was found to be 160° C.

Storage Stability

10 g of the toner was put into a 50 ml plastic cup and was left to stand still for 3 days in a thermostatic chamber kept at 50° C. Evaluation was made on how much the toner caused blocking after it was left to stand still.

A: The toner does not change in fluidity.
B: Its fluidity has become poor, but is recovered at once.
C: Agglomerates are seen, and can slightly not easily break.
D: The toner has no fluidity, or has caused caking, and is at a level not favorable in practical use.

### Examples 2 to 9 and Comparative Examples 2 to 9

Magnetic Toners 2 to 9 and Comparative Magnetic Toners 2 to 9 were also evaluated in the same way as in Example 1. The results are shown in Table 9.

TABLE 6

| | | | Number | | |
|---|---|---|---|---|---|
| | | | average | Magnetic properties | |
| Magnetic | Magnetic material treating agent | | particle | Magnetization | Residual |
| Iron | | Amount | diameter | intensity | magnetization |
| Oxide | Type | (part) | (μm) | (Am²/kg) | (Am²/kg) |
| 1 | Treating agents 2/3 | 0.6/0.9 | 0.25 | 68.6 | 3.7 |
| 2 | Treating agents 1/3 | 0.4/0.6 | 0.23 | 66.5 | 3.4 |
| 3 | Treating agents 1/2 | 0.2/1.3 | 0.21 | 69.3 | 4.2 |
| 4 | Treating agents 1/3 | 0.6/0.9 | 0.27 | 68.0 | 3.6 |
| 5 | Treating agents 2/4 | 0.2/1.0 | 0.22 | 68.6 | 3.7 |
| 6 | Treating agents 2/3 | 0.6/0.9 | 0.18 | 67.2 | 6.1 |
| 7 | Treating agents 1/3 | 0.3/0.2 | 0.23 | 68.6 | 3.7 |
| 8 | Treating agents 1/2/3 | 0.5/0.5/0.5 | 0.21 | 68.6 | 4.2 |
| 9 | Treating agent 2 | 1.0 | 0.25 | 68.6 | 3.4 |
| 10 | — | — | 0.25 | 68.6 | 3.6 |

Treating agent 1: n-C₄H₉Si(OCH₃)₃
Treating agent 2: n-C₆H₁₃Si(OCH₃)₃
Treating agent 3: n-C₈H₁₇Si(OC₂H₅)₃
Treating agent 4: n-C₁₀H₂₁Si(OCH₃)₃

TABLE 7

| | Magnetic | | | |
|---|---|---|---|---|
| | material | | | |
| | feed | Pretreatment | | |
| | rate | disintegration | | |
| Toner No. | C/E | step | Magnetic iron oxide | Production process |
| Magnetic Toner 1 | 5.3 × 10⁻⁴ | Yes | Magnetic Iron Oxide 1 | Suspension polymerizn |
| Magnetic Toner 2 | 5.3 × 10⁻⁴ | Yes | Magnetic Iron Oxide 2 | Suspension polymerizn |
| Magnetic Toner 3 | 2.7 × 10⁻³ | Yes | Magnetic Iron Oxide 3 | Suspension polymerizn |
| Magnetic Toner 4 | 1.6 × 10⁻³ | Yes | Magnetic Iron Oxide 4 | Suspension polymerizn |
| Magnetic Toner 5 | 2.7 × 10⁻⁴ | Yes | Magnetic Iron Oxide 5 | Suspension polymerizn |
| Magnetic Toner 6 | 1.6 × 10⁻³ | Yes | Magnetic Iron Oxide 3 | Suspension polymerizn |
| Magnetic Toner 7 | 2.7 × 10⁻⁴ | Yes | Magnetic Iron Oxide 2 | Suspension polymerizn |
| Magnetic Toner 8 | 2.1 × 10⁻³ | Yes | Magnetic Iron Oxide 6 | Suspension polymerizn |
| Magnetic Toner 9 | 2.7 × 10⁻³ | Yes | Magnetic Iron Oxide 1 | Suspension polymerizn |

Comparative:

| | | | | |
|---|---|---|---|---|
| Magnetic Toner 1 | 1.6 × 10⁻³ | Yes | Magnetic Iron Oxide 7 | Suspension polymerizn |
| Magnetic Toner 2 | 2.7 × 10⁻⁴ | Yes | Magnetic Iron Oxide 8 | Suspension polymerizn |
| Magnetic Toner 3 | 2.7 × 10⁻³ | Yes | Magnetic Iron Oxide 9 | Suspension polymerizn |
| Magnetic Toner 4 | 1.6 × 10⁻³ | Yes | Magnetic Iron Oxide 5 | Suspension polymerizn |
| Magnetic Toner 5 | — | Yes | Magnetic Iron Oxide | Pulverization |
| | | | 10 | |
| Magnetic Toner 6 | 4.2 × 10⁻³ | Yes | Magnetic Iron Oxide 3 | Suspension polymerizn |
| Magnetic Toner 7 | 3.2 × 10⁻³ | Yes | Magnetic Iron Oxide 4 | Suspension polymerizn |
| Magnetic Toner 8 | 4.2 × 10⁻³ | No | Magnetic Iron Oxide 4 | Suspension polymerizn |
| Magnetic Toner 9 | 2.7 × 10⁻³ | No | Magnetic Iron Oxide 3 | Suspension polymerizn |

TABLE 8

| | Weight | | | | | | | | |
|---|---|---|---|---|---|---|---|---|---|
| | average | | | | | | Magnetic properties | | |
| | particle | Dissolution by | | | | Dielectric | Magnetization | Residual | |
| | diameter | Hydrochloric acid | | | | loss factor | intensity | magnetization | Average |
| Toner No. | D4 (μm) | S₃ | S₁₅ | S₃₀ | S_{c} | tanδ | (Am²/kg) | (Am²/kg) | circularity |
| Magnetic Toner 1 | 7.8 | 4 | 64 | 86 | 2.7 | 4.8 × 10⁻³ | 29.4 | 1.6 | 0.965 |
| Magnetic Toner 2 | 7.7 | 9 | 70 | 97 | 2.3 | 4.3 × 10⁻³ | 28.5 | 1.5 | 0.969 |
| Magnetic Toner 3 | 8.0 | 3 | 77 | 85 | 9.3 | 1.4 × 10⁻² | 29.7 | 1.8 | 0.961 |
| Magnetic Toner 4 | 7.5 | 7 | 68 | 84 | 3.8 | 8.0 × 10⁻³ | 29.1 | 1.5 | 0.963 |
| Magnetic Toner 5 | 7.6 | 0.5 | 44 | 80 | 1.2 | 2.2 × 10⁻³ | 29.4 | 1.6 | 0.956 |
| Magnetic Toner 6 | 7.4 | 1.2 | 65 | 96 | 2.1 | 3.9 × 10⁻³ | 29.7 | 1.8 | 0.960 |
| Magnetic Toner 7 | 8.2 | 6 | 54 | 82 | 1.7 | 2.9 × 10⁻³ | 28.5 | 1.5 | 0.970 |
| Magnetic Toner 8 | 8.4 | 3 | 76 | 90 | 5.2 | 9.1 × 10⁻³ | 28.1 | 2.6 | 0.958 |
| Magnetic Toner 9 | 8.1 | 4 | 66 | 84 | 3.4 | 1.4 × 10⁻² | 29.4 | 1.6 | 0.951 |

Comparative:

| | | | | | | | | | |
|---|---|---|---|---|---|---|---|---|---|
| Magnetic Toner 1 | 8.6 | 14 | 60 | 90 | 1.5 | 2.6 × 10⁻³ | 29.4 | 1.6 | 0.961 |
| Magnetic Toner 2 | 8.5 | 1 | 42 | 83 | 1.0 | 1.4 × 10⁻³ | 29.4 | 1.8 | 0.955 |
| Magnetic Toner 3 | 8.2 | 2 | 82 | 95 | 6.2 | 9.8 × 10⁻³ | 29.4 | 1.5 | 0.958 |
| Magnetic Toner 4 | 8.3 | 1 | 92 | 98 | 15.2 | 1.7 × 10⁻² | 29.4 | 1.6 | 0.952 |
| Magnetic Toner 5 | 8.4 | 18 | 46 | 75 | 1.0 | 1.2 × 10⁻³ | 29.4 | 1.5 | 0.921 |
| Magnetic Toner 6 | 7.6 | 9 | 79 | 90 | 6.4 | 1.9 × 10⁻² | 29.5 | 1.8 | 0.961 |
| Magnetic Toner 7 | 7.8 | 7 | 86 | 91 | 15.8 | 1.6 × 10⁻² | 29.1 | 1.5 | 0.955 |
| Magnetic Toner 8 | 7.9 | 12 | 92 | 95 | 26.7 | 2.1 × 10⁻² | 29.1 | 1.5 | 0.948 |
| Magnetic Toner 9 | 8.2 | 6 | 81 | 88 | 10.7 | 1.8 × 10⁻² | 29.7 | 1.8 | 0.954 |

TABLE 9

| | Low-temp. | High-tem./low humidity | | | | |
|---|---|---|---|---|---|---|
| | environment | environment running | | | Low-temp. | |
| | Cardboard | Dot | Image | | fixing | Storage |
| Toner No. | fog | reproduceibility | density | Fog | performance | stability |

Example:

| | | | | | | | |
|---|---|---|---|---|---|---|---|
| 1 | Magnetic Toner 1 | 0.9% | A | A | 0.4% | 160° C. | A |
| 2 | Magnetic Toner 2 | 1.0% | A | A | 0.5% | 170° C. | A |
| 3 | Magnetic Toner 3 | 0.8% | B | B | 0.6% | 180° C. | B |
| 4 | Magnetic Toner 4 | 1.0% | A | A | 0.6% | 170° C. | B |
| 5 | Magnetic Toner 5 | 1.1% | A | C | 0.3% | 170° C. | A |
| 6 | Magnetic Toner 6 | 0.9% | A | B | 0.4% | 160° C. | A |
| 7 | Magnetic Toner 7 | 1.1% | B | B | 0.8% | 170° C. | B |
| 8 | Magnetic Toner 8 | 0.8% | C | B | 0.7% | 170° C. | A |
| 9 | Magnetic Toner 9 | 1.1% | B | C | 0.3% | 160° C. | B |

Comparative Example:

| | | | | | | | |
|---|---|---|---|---|---|---|---|
| 1 | Comp. Magnetic Toner 1 | 1.7% | D | D | 0.7% | 170° C. | D |
| 2 | Comp. Magnetic Toner 2 | 2.2% | C | C | 0.9% | 170° C. | B |
| 3 | Comp. Magnetic Toner 3 | 1.8% | B | C | 0.8% | 180° C. | C |
| 4 | Comp. Magnetic Toner 4 | 1.9% | C | C | 0.4% | 190° C. | D |
| 5 | Comp. Magnetic Toner 5 | 1.4% | D | D | 0.7% | 180° C. | D |
| 6 | Comp. Magnetic Toner 6 | 2.3% | D | C | 0.9% | 170° C. | C |
| 7 | Comp. Magnetic Toner 7 | 2.2% | C | C | 0.8% | 180° C. | C |
| 8 | Comp. Magnetic Toner 8 | 2.7% | C | D | 0.9% | 190° C. | D |
| 9 | Comp. Magnetic Toner 9 | 1.7% | C | D | 0.7% | 180° C. | B |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2007-283188, filed on Oct. 31, 2007, which is herein incorporated by reference as part of this application.

What is claimed is:

1. A magnetic toner which comprises magnetic toner particles containing at least a binder resin and a magnetic material, wherein;
in a test in which the magnetic toner is dispersed in 5 mol/liter hydrochloric acid to dissolve the magnetic material, and where the dissolution percentage of the magnetic material with respect to the total content of the magnetic material at a point of time of 3 minutes after the magnetic toner has begun to be dispersed in the hydrochloric acid is represented by S₃ (% by mass) and the dissolution percentage of the magnetic material with respect to the total content of the magnetic material at a point of time of 15 minutes after the magnetic toner has begun to be dispersed in the hydrochloric acid is represented by S₁₅ (% by mass), the S₃ and the S₁₅ satisfy the following expressions:
0.5≦S₃≦10,
40≦S₁₅≦80;
where the dissolution percentage of the magnetic material with respect to the total content of the magnetic material at a point of time of 30 minutes after the magnetic toner has begun to be dispersed in the hydrochloric acid is represented by S₃₀ (% by mass), the proportion S_{c} of the dissolution level of the magnetic material at from 3 minutes to 15 minutes after the magnetic toner has begun to be dispersed in the hydrochloric acid to the dissolution level of the magnetic material at from 15 minutes to 30 minutes after the magnetic toner has begun to be dispersed in the hydrochloric acid, represented by (S₁₅−S₃)/(S₃₀−S₁₅), satisfies the following expressions:
1.2≦S_{c}[=(S₁₅−S₃)/(S₃₀−S₁₅)]≦10; and
the magnetic toner has a dielectric loss factor (tan δ) at 25° C. and at a frequency 1.0×10⁴ Hz, within the range of from 2.0×10⁻³ or more to 1.5×10⁻² or less.

2. The magnetic toner according to claim 1, wherein the dissolution percentage (S₃₀) of the magnetic material with respect to the total content of the magnetic material at a point of time of 30 minutes after the magnetic toner has begun to be dispersed in 5 mol/liter hydrochloric acid is 80% by mass or more.

3. The magnetic toner according to claim 1, which has an average circularity of 0.960 or more.

4. The magnetic toner according to claim 1, wherein the magnetic material contained in the magnetic toner is a magnetic iron oxide having been subjected to hydrophobic treatment.

5. The magnetic toner according to claim 1, which has a residual magnetization of 2.5 Am²/kg or less when the magnetic toner is magnetized in a magnetic field of 79.6 kA/m (1,000 oersteds).

6. The magnetic toner according to claim 1, which has a magnetization intensity of from 23.0 Am²/kg or more to 33.0 Am²/kg or less when the magnetic toner is magnetized in a magnetic field of 79.6 kA/m (1,000 oersteds).

7. The magnetic toner according to claim 1, wherein the magnetic toner particles have been produced in an aqueous medium.

8. The magnetic toner according to claim 7, wherein the magnetic toner particles have been produced by a suspension polymerization process.
